(19) United States
(12) Patent Application Publication
(10) Pub. No.: US 2011/0118870 A1
(43) Pub. Date: May 19, 2011

(54) ROBOT CONTROL SYSTEM, ROBOT, PROGRAM, AND INFORMATION STORAGE MEDIUM

(75) Inventors: Ryohei Sugihara, Tokyo (JP); Seiji Tatsuta, Tokyo (JP); Yoichi Iba, Tokyo (JP); Nobuto Fukushima, Saitama (JP); Tsuneharu Kasai, Saitama (JP); Hideki Shimizu, Saitama (JP)

(73) Assignee: OLYMPUS CORPORATION, Tokyo (JP)

(21) Appl. No.: 12/676,729

(22) PCT Filed: Sep. 1, 2008
(86) PCT No.: PCT/JP2008/065642

§ 371 Date: Jan. 13, 2011

(30) Foreign Application Priority Data
Sep. 6, 2007 (JP) 2007-231482
Nov. 30, 2007 (JP) 2007-309625

(51) Int. Cl. B25J 13/00

(52) U.S. Cl. 700/245

(57) ABSTRACT

A robot control system includes a user information acquisition section (12) that acquires user information that is obtained based on sensor information from at least one of a behavior sensor that measures a behavior of a user, a condition sensor that measures a condition of the user, and an environment sensor that measures an environment of the user, a presentation information determination section (14) that determines presentation information that is presented to the user by the robot based on the acquired user information, and a robot control section (30) that controls the robot to present the presentation information to the user. The user information acquisition section (12) acquires second user information that is the user information about a second user, and the presentation information determination section (14) determines the presentation information presented to a first user based on the acquired second user information. The robot control section (30) causes the robot to present the presentation information determined based on the second user information to the first user.

### TECHNICAL FIELD

The present invention relates to a robot control system, a robot, a program, an information storage medium, and the like.

### BACKGROUND ART

A robot control system that recognizes the voice of the user (human) and implements a conversation with the user based on the voice recognition result has been known (JP-A-2003-66986, for example).

However, a related-art robot control system is configured on the assumption that the robot operates based on the voice of the user (owner) determined by voice recognition, and does not control the robot while reflecting behavior etc. of the user.

Moreover, a related-art robot control system does not control the robot while reflecting the behavior history, condition history, etc. of the user. Therefore, the robot may perform an operation that is not appropriate for the mental state or the condition of the user.

A related-art robot control system is configured on the assumption that one robot talks to one user. Therefore, since a complex algorithm is required for a voice recognition process and a conversational process, it is difficult to implement a smooth conversation with the user.

### DISCLOSURE OF THE INVENTION

Several aspects of the invention may provide a robot control system, a robot, a program, and an information storage medium that implement robot control that implement indirect communication between the users through a robot.

One aspect of the invention relates to a robot control system that controls a robot, the robot control system comprising: a user information acquisition section that acquires user information that is obtained based on sensor information from at least one of a behavior sensor that measures a behavior of a user, a condition sensor that measures a condition of the user, and an environment sensor that measures an environment of the user; a presentation information determination section that determines presentation information presented to the user by the robot based on the acquired user information; and a robot control section that controls the robot to present the presentation information to the user, the user information acquisition section acquiring second user information that is the user information about a second user; the presentation information determination section determining the presentation information presented to a first user based on the acquired second user information; and the robot control section causing the robot to present the presentation information determined based on the second user information to the first user. Another aspect of the invention relates to a program that causes a computer to function as each of the above sections, or a computer-readable information storage medium storing the program.

According to one aspect of the invention, the user information that is obtained based on the sensor information from at least one of the behavior sensor, the condition sensor, and the environment sensor is acquired. The presentation information that is presented to the user by the robot is determined based on the acquired user information, and the robot is controlled to present the presentation information. The presentation information presented to the first user is determined based on the acquired second user information about the second user, and the determined presentation information is presented to the first user. Specifically, the presentation information presented to the first user by the robot is determined based on the second user information about the second user different from the first user. Therefore, the first user can be indirectly notified of the behavior, condition, etc. of the second user based on the presentation information presented by the robot so that indirect communication between the users through the robot can be implemented.

In the robot control system according to one aspect of the invention, the user information acquisition section may acquire first user information that is the user information about the first user, and the second user information that is the user information about the second user; and the presentation information determination section may determine the presentation information presented to the first user based on the acquired first user information and the acquired second user information.

This makes it possible to provide the first user with the presentation information based on the second user information while taking account of the first user information about the first user.

In the robot control system according to one aspect of the invention, the presentation information determination section may determine a presentation timing of the presentation information based on the first user information, and determine a content of the presentation information based on the second user information; and the robot control section may cause the robot to present the presentation information having the determined content to the first user at the determined presentation timing.

This makes it possible to notify the first user of the information about the second user at an appropriate so that more natural and smoother information presentation can be implemented.

In the robot control system according to one aspect of the invention, the presentation information determination section may change weighting of the first user information and weighting of the second user information when determining the presentation information presented to the first user with the passage of time.

This makes it possible to provide the first user with the information based on the second user information while taking account of the first user information. Since the weighting of the first user information that determines the degree of taking account of the first user information changes with the passage of time, more diverse and natural information presentation can be implemented.

The robot control system according to one aspect of the invention may further comprise: an event determination section that determines occurrence of an available event that indicates that the robot is available to the first user, wherein the presentation information determination section may increase the weighting of the first user information while decreasing the weighting of the second user information when determining the presentation information when the available event has occurred, and then decrease the weighting of the first user information while increasing the weighting of the second user information.

According to this configuration, since the weighting of the second user information when determining the presentation information increases with the passage of time from the occurrence of the robot available event, more natural information presentation can be implemented.

In the robot control system according to one aspect of the invention, the presentation information determination section may determine the presentation information that is subsequently presented to the first user by the robot based on a reaction of the first user to the presentation information that has been presented by the robot.

According to this configuration, since the subsequent presentation information changes based on the reaction of the first user to the presentation information, a situation in which presentation of the presentation information by the robot becomes monotonous can be prevented.

The robot control system according to one aspect of the invention may further comprise: a contact state determination section that determines a contact state on a sensing surface of the robot, wherein the presentation information determination section may determine whether the first user has stroked or hit the robot as the reaction of the first user to the presentation information presented by the robot based on the determination result of the contact state determination section, and determine the presentation information that is subsequently presented to the first user.

This makes it possible to determine the reaction (e.g., stroke operation or hit operation) of the first user by a simple determination process.

In the robot control system according to one aspect of the invention, the contact state determination section may determine the contact state on the sensing surface based on output data obtained by performing a calculation process on an output signal from a microphone provided under the sensing surface.

This makes it possible to detect the reaction (e.g., stroke operation or hit operation) of the first user by merely utilizing the microphone.

In the robot control system according to one aspect of the invention, the output data may be a signal strength; and the contact state determination section may compare the signal strength with a given threshold value to determine whether the first user has stroked or hit the robot.

According to this configuration, whether the first user has stroked or hit the robot can be determined by a simple process that compares the signal strength with the threshold value.

In the robot control system according to one aspect of the invention, the presentation information determination section may determine the presentation information presented to the first user so that a first robot and a second robot present different types of presentation information based on the identical acquired second user information.

This makes it possible for the first user to be indirectly notified of the information about the second user through the presentation information presented by the first robot and the second robot.

In the robot control system according to one aspect of the invention, the first robot may be set as a master, and the second robot may be set as a slave; and the presentation information determination section provided in the master-side first robot may instruct the slave-side second robot to present the presentation information to the first user.

According to this configuration, the presentation information can be presented using the first robot and the second robot under stable control (i.e., malfunctions rarely occur) without utilizing a complex presentation information analysis process.

The robot control system according to one aspect of the invention may further comprise a communication section that transmits instruction information from the master-side first robot to the slave-side second robot, the instruction information instructing presentation of the presentation information.

According to this configuration, since it suffices to transmit the instruction information instead of the presentation information, the amount of communication data can be reduced while simplifying the process.

In the robot control system according to one aspect of the invention, the user information acquisition section may acquire the second user information about the second user through a network; and the presentation information determination section may determine the presentation information presented to the first user based on the second user information acquired through the network.

This makes it possible to implement robot control that reflects the information about the second user, even when the second user is situated at a distance apart from the first user, for example.

In the robot control system according to one aspect of the invention, the user information acquisition section may acquire second user historical information as the second user information, the second user historical information being at least one of a behavior history, a condition history, and an environment history of the second user; and the presentation information determination section may determine the presentation information that is presented to the first user by the robot based on the acquired second user historical information.

This makes it possible to present the presentation information that reflects the behavior history, condition history, or environment history of the second user using the robot.

In the robot control system according to one aspect of the invention, the second user historical information may be information that is updated based on sensor information from a wearable sensor of the second user.

This makes it possible to update the behavior history, condition history, or environment history of the second user based on the sensor information from the wearable sensor, and present the presentation information that reflects the behavior history, condition history, or environment history of the second user using the robot.

The robot control system according to one aspect of the invention may further comprise: a user identification section that identifies a user who has approached the robot, wherein the robot control section may cause the robot to present the presentation information to the first user when the user identification section has determined that the first user has approached the robot.

This makes it possible to provide the first user with the presentation information based on the second user information when the user has approached the robot and identified as the first user.

The robot control system according to one aspect of the invention may further comprise: a presentation permission determination information storage section that stores presentation permission determination information that indicates whether or not to allow information presentation between users, wherein the presentation information determination section may determine the presentation information presented to the first user based on the second user information when the presentation information determination section has determined that information presentation between the first user and the second user is allowed based on the presentation permission determination information.

This makes it possible to allow indirect communication through the robot only between specific users.

The robot control system according to one aspect of the invention may further comprise: a scenario data storage section that stores scenario data that includes a plurality of phrases as the presentation information, wherein the presentation information determination section may determine a phrase spoken to the first user by the robot based on the scenario data; and the robot control section may cause the robot to speak the determined phrase.

This makes it possible to cause the robot to speak a phrase by a simple control process utilizing the scenario data.

In the robot control system according to one aspect of the invention, the scenario data storage section may store the scenario data in which a plurality of phrases are linked by a branched structure; and the presentation information determination section may determine a phrase that is subsequently spoken by the robot based on a reaction of the first user to the phrase that has been spoken by the robot.

According to this configuration, the phrase that is subsequently spoken by the robot changes based on the reaction of the first user to the phrase that has been spoken by the robot so that a situation in which a conversation with the robot becomes monotonous can be prevented.

The robot control system according to one aspect of the invention may further comprise: a scenario data acquisition section that acquires scenario data created based on a reaction of the second user to the phrase spoken by the robot, wherein the presentation information determination section may determine a phrase spoken to the first user by the robot based on the scenario data acquired based on the reaction of the second user.

According to this configuration, a phrase spoken to the first user by the robot can be determined based on the scenario data that reflects the reaction of the second user to the phrase spoken by the robot.

In the robot control system according to one aspect of the invention, the presentation information determination section may determine a phrase spoken to the first user so that a first robot and a second robot speak different phrases based on the identical acquired second user information; and the robot control system may further comprise a speak right control section that controls whether to give a next phrase speak right to the first robot or the second robot based on a reaction of the first user to the phrase that has been spoken by the robot.

According to this configuration, since the speak right is given depending on the reaction of the first user, a situation in which a conversation becomes monotonous can be prevented.

In the robot control system according to one aspect of the invention, the speak right control section may determine a robot to which the next phrase speak right is given, based on whether the first user has made a positive reaction or a negative reaction to the phrase spoken by the first robot or the second robot.

This makes it possible to preferentially give the speak right to the robot for which the first user has made a positive reaction.

A further aspect of the invention relates to a robot comprising: the above robot control system; and a robot motion mechanism that is a control target of the robot control system.

### BRIEF DESCRIPTION OF THE DRAWINGS

FIG. 1 is a view illustrative of a user information acquisition method.

FIG. 2 shows a system configuration example according to one embodiment of the invention.

FIGS. 3A to 3C are views illustrative of a method according to one embodiment of the invention.

FIG. 4 is a flowchart illustrative of an operation according to one embodiment of the invention.

FIG. 5 shows a second system configuration example according to one embodiment of the invention in which a plurality of robots are used.

FIGS. 6A to 6C are views illustrative of a second user information acquisition method.

FIGS. 7A to 7C are views illustrative of a method of presenting information to a first user.

FIG. 8 is a flowchart illustrative of the operation of the second system configuration.

FIG. 9 shows a third system configuration example according to one embodiment of the invention.

FIG. 10 is a view illustrative of a second user information acquisition method through a network.

FIG. 11 shows a fourth system configuration example according to one embodiment of the invention.

FIG. 12 shows a fifth system configuration example according to one embodiment of the invention.

FIG. 13 is a flowchart showing a user historical information update process.

FIG. 14 is a view illustrative of user historical information.

FIGS. 15A and 15B are views illustrative of user historical information.

FIG. 16 shows a detailed system configuration example according to one embodiment of the invention.

FIGS. 17A and 17B are views illustrative of a speak right control method.

FIGS. 18A and 18B are views illustrative of a speak right control method.

FIG. 19 is a view illustrative of presentation permission determination information.

FIG. 20 is a flowchart illustrative of a detailed operation according to one embodiment of the invention.

FIG. 21 is a view illustrative of scenario data.

FIG. 22 shows an example of a scenario that present a topic concerning a child to a father.

FIG. 23 is a view illustrative of an example of a scenario used to collect user information about a child.

FIG. 24 shows an example of a scenario presented to a father based on collected second user information.

FIGS. 25A and 25B are views illustrative of a contact determination method.

FIGS. 26A, 26B, and 26C show voice waveform examples when hitting a sensing surface, stroking a sensing surface, and speaking into a microphone.

FIG. 27 is a view illustrative of a presentation information determination method based on first user information and second user information.

FIG. 28 is a view illustrative of a presentation information determination process based on first user information and second user information.

### BEST MODE FOR CARRYING OUT THE INVENTION

Embodiments of the invention are described below. Note that the following embodiments do not in any way limit the scope of the invention laid out in the claims. Note that all elements of the following embodiments should not necessarily be taken as essential requirements for the invention.

1. User Information

As a ubiquitous service, a convenience provision service that aims at providing the user with necessary information anywhere and anytime has been proposed. The convenience provision service externally and unilaterally provides information to the user.

However, the convenience provision service that externally and unilaterally provides information to the user is insufficient for a person to enjoy an active and full life. Therefore, it is desirable to provide an inspiring ubiquitous service that inspires the user to be aware of something by appealing to the user's mind to promote personal growth of the user.

In this embodiment, user information (first user information and second user information) is acquired based on sensor information from a behavior sensor, a condition sensor, and an environment sensor that respectively measure the behavior, the condition, and the environment of the user (first user and second user) in order to implement an inspiring ubiquitous service by utilizing information that is presented to the user by a robot. Presentation information (e.g., conversation) that is presented to the user by a robot is determined based on the acquired user information, and the robot is controlled to provide the determined presentation information to the user. A method of acquiring the user information (information about at least one of the behavior, the condition, and the environment of the user) is described below.

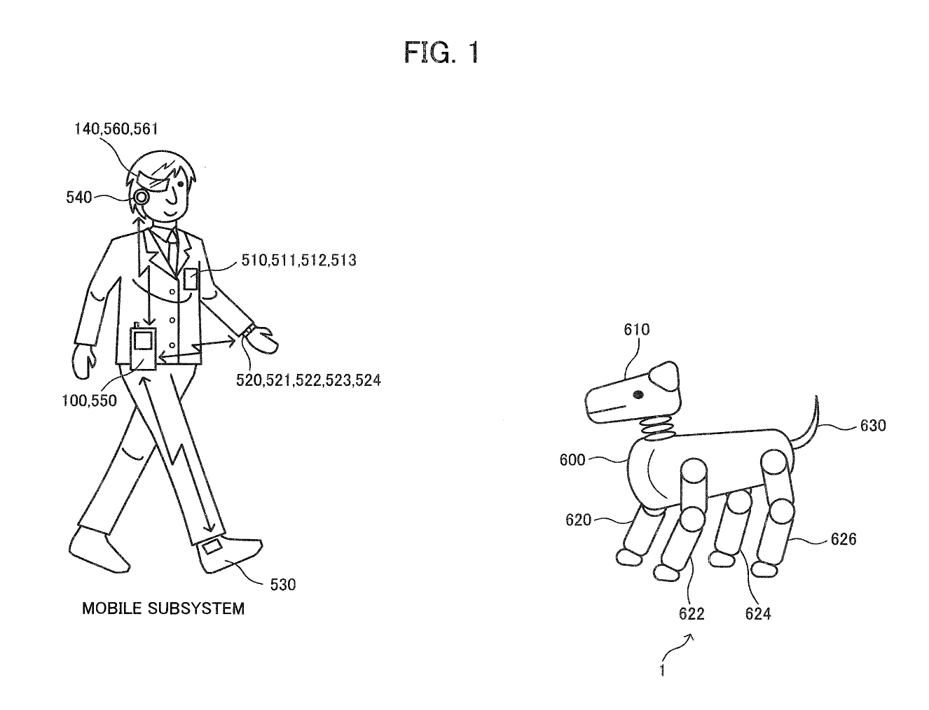

In FIG. 1, the user carries a portable electronic instrument 100 (mobile gateway). The user wears a wearable display 140 (mobile display) near one of the eyes as a mobile control target instrument. The user also wears various sensors as wearable sensors (mobile sensors). Specifically, the user wears an indoor/outdoor sensor 510, an ambient temperature sensor 511, an ambient humidity sensor 512, an ambient luminance sensor 513, a wrist-mounted movement measurement sensor 520, a pulse (heart rate) sensor 521, a body temperature sensor 522, a peripheral skin temperature sensor 523, a sweat sensor 524, a foot pressure sensor 530, a speech/mastication sensor 540, a Global Position System (GPS) sensor 550 provided in the portable electronic instrument 100, a complexion sensor 560 and a pupil sensor 561 provided in the wearable display 140, and the like. A mobile subsystem is formed by the portable electronic instrument 100, the mobile control target instruments such as the wearable display 140, and the wearable sensors.

In FIG. 1, user information (user historical information in a narrow sense) that is updated based on the sensor information from the sensors of the mobile subsystem of the user is acquired, and a robot 1 is controlled based on the acquired user information.

The portable electronic instrument 100 (mobile gateway) is a portable information terminal such as a personal digital assistant (PDA) or a notebook PC, and includes a processor (CPU), a memory, an operation panel, a communication device, a display (sub-display), and the like. The portable electronic instrument 100 may have a function of collecting sensor information from a sensor, a function of performing a calculation process based on the collected sensor information, a function of controlling (e.g., display control) the control target instrument (e.g., wearable display) or acquiring information from an external database based on the calculation results, a function of communicating with the outside, and the like. Note that the portable electronic instrument 100 may be an instrument that is used as a portable telephone, a wristwatch, a portable audio player, or the like.

The user wears the wearable display 140 near one of his eyes. The wearable display 140 is set so that the display section is smaller than the pupil, and functions as a see-through viewer information display section. Information may be presented (provided) to the user using a headphone, a vibrator, or the like. Examples of the mobile control target instrument other than the wearable display 140 include a wristwatch, a portable telephone, a portable audio player, and the like.

The indoor/outdoor sensor detects whether the user stays in a room or stays outdoors. For example, the indoor/outdoor sensor emits ultrasonic waves, and measures the time required for the ultrasonic waves to be reflected by a ceiling or the like and return to the indoor/outdoor sensor. The indoor/outdoor sensor 510 is not limited to an ultrasonic sensor, but may be an active optical sensor, a passive ultraviolet sensor, a passive infrared sensor, or passive noise sensor.

The ambient temperature sensor 511 measures the ambient temperature using a thermistor, a radiation thermometer, a thermocouple, or the like. The ambient humidity sensor 512 measures the ambient humidity by utilizing a phenomenon in which an electrical resistance changes due to humidity, for example. The ambient luminance sensor 513 measures the ambient luminance using a photoelectric element, for example.

The wrist-mounted movement measurement sensor 520 measures the movement of the arm of the user using an acceleration sensor or an angular acceleration sensor. The daily performance and the walking state of the user can be more accurately measured using the movement measurement sensor 520 and the foot pressure sensor 530. The pulse (heart rate) sensor 521 is attached to the wrist, finger, or ear of the user, and measures a change in bloodstream due to pulsation based on a change in transmittance or reflectance of infrared light. The body temperature sensor 522 and the peripheral skin temperature sensor 523 measure the body temperature and the peripheral skin temperature of the user using a thermistor, a radiation thermometer, a thermocouple, or the like. The sweat sensor 524 measures skin perspiration based on a change in the surface resistance of the skin, for example. The foot pressure sensor 530 detects the distribution of pressure applied to the shoe, and determines that the user is in a standing state, a sitting state, a walking state, or the like.

The speech/mastication sensor 540 is an earphone-type sensor that measures the possibility that the user speaks (conversation) or masticates (eating). The speech/mastication sensor 540 includes a bone conduction microphone and an ambient sound microphone provided in a housing. The bone conduction microphone detects body sound that is a vibration that occurs from the body during speech/mastication and is propagated inside the body. The ambient sound microphone detects voice that is a vibration that is transmitted to the outside of the body due to speech, or ambient sound including environmental noise. The speech/mastication sensor 540 measures the possibility that the user speaks or masticates by comparing the power of the sound captured by the bone conduction microphone with the power of the sound captured by the ambient sound microphone per unit time, for example.

The GPS sensor 550 detects the position of the user. Note that a portable telephone position information service or peripheral wireless LAN position information may be utilized instead of the GPS sensor 550. The complexion sensor 560 includes an optical sensor disposed near the face, and compares the luminance of light through a plurality of optical band-pass filters to measure the complexion, for example. The pupil sensor 561 includes a camera disposed near the pupil, and analyzes a camera signal to measure the size of the pupil, for example.

In FIG. 1, the user information is acquired by the mobile subsystem formed by the portable electronic instrument 100, the wearable sensors, and the like. Note that the user information may be updated by an integrated system that includes a plurality of subsystems, and the robot 1 may be controlled based on the updated user information. The integrated system may include a mobile subsystem, a home subsystem, a car subsystem, a company subsystem, a store subsystem, and the like.

When the user stays outdoors (i.e., mobile environment), for example, the integrated system acquires (collects) the sensor information (including secondary sensor information) from the wearable sensors (mobile sensors) of the mobile subsystem, and updates the user information (user historical information) based on the acquired sensor information. The integrated system controls the mobile control target instrument based on the user information and the like.

When the user stays home (i.e., home environment), the integrated system acquires the sensor information from home sensors of the home subsystem, and updates the user information based on the acquired sensor information. Specifically, the user information that has been updated in the mobile environment is seamlessly updated in the home environment. The integrated system controls a home control target instrument (e.g., television, audio instrument, and air conditioner) based on the user information and the like. Examples of the home sensors include an environment sensor that measures the temperature, humidity, luminance, noise, conversation, meal times, etc. in the home, a robot-mounted sensor provided in a robot, a person detection sensor provided in each room, door, etc., a urine check sensor provided in a rest room, and the like.

When the user rides in a car (i.e., car environment), the integrated system acquires the sensor information from car sensors of the car subsystem, and updates the user information based on the acquired sensor information. Specifically, the user information that has been updated in the mobile environment or the home environment is seamlessly updated in the car environment. The integrated system controls a car control target instrument (e.g., navigation system, car AV instrument, and air conditioner) based on the user information and the like. Examples of the car sensors include a travel sensor that measure the speed, travel distance, etc. of the car, an operation sensor that measures the user's drive operation and instrument operation, an environment sensor that measures the temperature, humidity, luminance, conversation etc. in the car, and the like.

2. Robot

The configuration of the robot 1 (robot 2) shown in FIG. 1 is described below. The robot 1 is a pet-type robot that imitates a dog. The robot 1 includes a plurality of part modules (robot motion mechanisms) such as a body module 600, a head module 610, leg modules 620, 622, 624, 626, and a tail module 630.

The head module 610 includes a touch sensor that detects a stroke operation or a hit operation of the user, a speech sensor (microphone) that detects speech of the user, an image sensor (camera) for image recognition, and a sound output section (speaker) that outputs voice or a call.

A joint mechanism is provided between the body module 600 and the head module 610, between the body module 600 and the tail module 630, and at the joint of the leg module 620, for example. These joint mechanisms include an actuator such as a motor so that joint movement or self-travel of the robot 1 is implemented.

The body module 600 of the robot 1 includes one or more circuit boards, for example. The circuit board is provided with a CPU (processor) that performs various processes, a memory (e.g., ROM or RAM) that stores data and a program, a robot control IC, a sound generation module that generates a sound signal, a wireless module that implements wireless communication with the outside, and the like. A signal from each sensor mounted on the robot is transmitted to the circuit board, and processed by the CPU and the like. The sound signal generated by the sound generation module is output to the sound output section (speaker) from the circuit board. A control signal from the control IC of the circuit board is output to the actuator (e.g., motor) provided in the joint mechanism so that joint movement or self-travel of the robot 1 is controlled.

3. Robot Control System

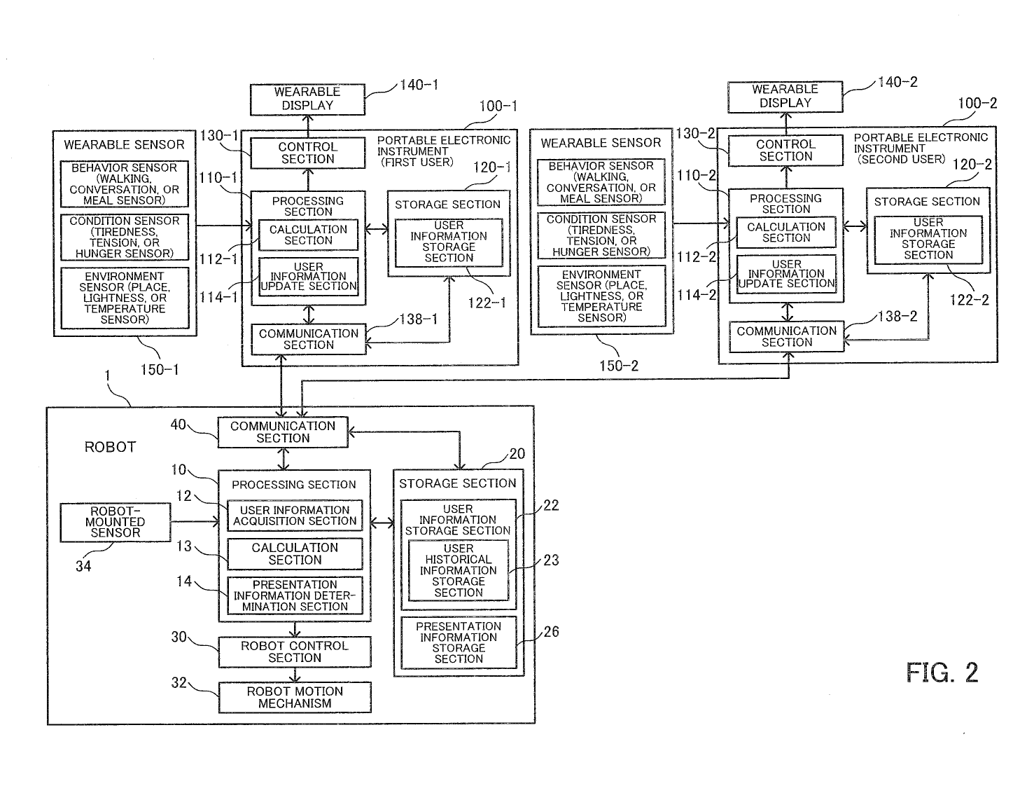

FIG. 2 shows a system configuration example according to this embodiment. The system shown in FIG. 2 includes a portable electronic instrument 100-1 carried by the first user, a portable electronic instrument 100-2 carried by the second user, and the robot 1 that is controlled by the robot control system according to this embodiment The robot control system according to this embodiment is implemented by a processing section 10 included in the robot 1, for example.

The first user may be the owner of the robot 1, for example. The second user may be a family, a friend, a relative, a lover, or the like of the owner of the robot 1. Alternatively, the first user and the second user may be co-owners of the robot 1.

The portable electronic instrument 100-1 carried by the first user includes a processing section 110-1, a storage section 120-1, a control section 130-1, and a communication section 138-1. The portable electronic instrument 100-2 carried by the second user includes a processing section 110-2, a storage section 120-2, a control section 130-2, and a communication section 138-2.

Note that the portable electronic instruments 100-1 and 100-2, the processing sections 110-1 and 110-2, the storage sections 120-1 and 120-2, the control sections 130-1 and 130-2, the communication sections 138-1 and 138-2, and the like may be appropriately referred to as a portable electronic instrument 100, a processing section 110, a storage section 120, a control section 130, a communication section 138, and the like, respectively, for convenience. The first user and the second user, the first user information and the second user information, and the first user historical information and the second user historical information may also be appropriately referred to as a user, user information, and user historical information, respectively.

The portable electronic instrument 100 (100-1, 100-2) acquires sensor information from a wearable sensor 150 (150-1, 150-2). Specifically, the wearable sensor 150 includes at least one of a behavior sensor that measures the behavior (e.g., walk, conversation, meal, movement of hands and feet, emotion, or sleep) of the user (first user and second user), a condition sensor that measures the condition (e.g., tiredness, tension, hunger, mental state, physical condition, or event that has occurred) of the user, and an environment sensor that measures the environment (place, lightness, temperature, or humidity) of the user. The portable electronic instrument 100 acquires sensor information from these sensors.

Note that the sensor may be a sensor device, or may be a sensor instrument that includes a sensor device, a control section, a communication section, and the like. The sensor information may be primary sensor information that is directly obtained from the sensor, or may be secondary sensor information that is obtained by processing (information processing) the primary sensor information.

The processing section 110 (100-1, 100-2) performs various processes (e.g., a process required to operate the portable electronic instrument 100) based on operation information from an operation section (not shown), the sensor information acquired from the wearable sensor 150, and the like. The function of the processing section 110 may be implemented by hardware such as a processor (e.g., CPU) or an ASIC (e.g., gate array), a program stored in an information storage medium (e.g., optical disk, IC card, or HDD) (not shown), or the like.

The processing section 110 includes a calculation section 112 (112-1, 112-2) and a user information update section 114 (114-1, 114-2). The calculation section 112 performs various calculation processes for filtering (selecting) or analyzing the sensor information acquired from the wearable sensor 150. Specifically, the calculation section 112 performs a multiplication process or an addition process on the sensor information. For example, as shown by the following expression (1), digitized measured values Xⱼ of a plurality of pieces of sensor information from a plurality of sensors and each coefficient are stored in a coefficient storage section (not shown), and the calculation section 112 performs product-sum calculations on the measured values Xⱼ and coefficients Aᵢⱼ indicated by a two-dimensional matrix. As shown by the following expression (2), the calculation section 112 calculates the n-dimensional vector Yᵢ using the product-sum calculation results as multi-dimensional coordinates. Note that i is the i coordinate in the n-dimensional space, and j is a number assigned to each sensor.

$$\begin{matrix}( \begin{matrix}{Y}_{0} \\ {Y}_{1} \\ {Y}_{2} \\ ⋮ \\ {Y}_{i} \\ ⋮ \\ {Y}_{n}\end{matrix} ) = ( \begin{matrix}{A}_{00} & … & … & … & {A}_{0 m} \\ ⋮ & & & & ⋮ \\ ⋮ & & {A}_{ij} & & ⋮ \\ ⋮ & & & & ⋮ \\ {A}_{n 0} & … & … & … & {A}_{nm}\end{matrix} ) ( \begin{matrix}{X}_{0} \\ {X}_{1} \\ {X}_{2} \\ ⋮ \\ {X}_{j} \\ ⋮ \\ {X}_{m}\end{matrix} ) & ( 1 ) \\ {Y}_{i} = {A}_{00} {X}_{0} + … + {A}_{ij} {X}_{j} … + {A}_{nm} {X}_{m} & ( 2 )\end{matrix}$$

A filtering process that removes unnecessary sensor information from the acquired sensor information, an analysis process that determines the behavior, the condition, and the environment (Time, Place and Occasion information; hereafter TPO information) of the user based on the sensor information, and the like can be implemented by performing the calculation process shown by the expressions (1) and (2). For example, if the coefficients A that are multiplied by the pulse (heart rate), perspiration amount, and body temperature measured values X are set to be larger than the coefficients that are multiplied by other sensor information measured values, the value Y calculated by the expressions (1) and (2) indicates the excitement level (condition) of the user. It is also possible to determine whether the user is seated and talks, talks while walking, thinks quietly, or sleeps by appropriately setting the coefficient that is multiplied by the speech measured value X and the coefficient that is multiplied by the foot pressure measured value X.

The user information update section 114 (114-1, 114-2) updates the user information (user historical information). Specifically, the user information update section 114 updates the user information (first user information and second user information) based on the sensor information acquired from the wearable sensor 150 (150-1, 150-2). The user information update section 114 stores the updated user information (user historical information) in a user information storage section 122 (user historical information storage section) of the storage section 120. In order to save the memory capacity of the user information storage section 122 (122-1, 122-2), old user information may be deleted when storing new user information, and the new user information may be stored in the storage area in which the old user information has been stored. Alternatively, an order of priority (weighting coefficient) may be assigned to each piece of user information, and the user information with a lower order of priority may be deleted when storing new user information. The user information may be updated (overwritten) by performing calculations on the user information that has been stored and the new user information.

The storage section 120 (120-1, 120-2) serves as a work area for the processing section 110, the communication section 138, and the like. The function of the storage section 120 may be implemented by a memory (e.g., RAM), a hard disk drive (HDD), or the like. A user information storage section 122 included in the storage section 120 stores the user information (first user information and second user information) that is information (historical information) about the behavior, condition, environment, etc. of the user (first user and second user) and is updated based on the acquired sensor information.

The control section 130 (130-1, 130-2) controls the wearable display 140 (140-1, 140-2) and the like. The communication section 138 (138-1, 138-2) transmits and receives information (e.g., user information) to and from a communication section 40 of the robot 1 via wireless or cable communication. As wireless communication, short-distance wireless communication utilizing Bluetooth (registered trademark) or infrared radiation, a wireless LAN, or the like may be used. As cable communication, communication utilizing USB, IEEE 1394, or the like may be used.

The robot 1 includes a processing section 10, a storage section 20, a robot control section 30, a robot motion mechanism 32, a robot-mounted sensor 34, and the communication section 40. Note that the robot 1 may have a configuration in which some of these sections are omitted.

The processing section 10 performs various processes (e.g., a process that causes the robot 1 to operate) based on sensor information from the robot-mounted sensor 34, the acquired user information, and the like. The function of the processing section 10 may be implemented by hardware such as a processor (e.g., CPU) or an ASIC (e.g., gate array), a program stored in an information storage medium (e.g., optical disk, IC card, or HDD) (not shown), or the like. Specifically, the information storage medium stores a program that causes a computer (i.e., a device that includes an operation section, a processing section, a storage section, and an output section) to function as each section according to this embodiment (i.e., a program that causes a computer to execute the process of each section), and the processing section 10 performs various processes according to this embodiment based on the program (data) stored in the information storage medium.

The storage section 20 serves as a work area for the processing section 10, the communication section 40, and the like. The function of the storage section 20 may be implemented by a memory (e.g., RAM), a hard disk drive (HDD), or the like. The storage section 20 includes a user information storage section 22 and a presentation information storage section 26. The user information storage section 22 includes a user historical information storage section 23.

The robot control section 30 controls the robot motion mechanism 32 (e.g., actuator, sound output section, or LED) (control target). The function of the robot control section 30 may be implemented by hardware such as a robot control ASIC or a processor, a program, or the like.

Specifically, the robot control section 30 causes the robot 1 to present the presentation information to the user. When the presentation information indicates a conversation (scenario data) of the robot 1, the robot control section 30 causes the robot 1 to speak a phrase. For example, the robot control section 30 converts digital text data that indicates the phrase into an analog sound signal by a text-to-speech (TTS) process, and outputs the sound through a sound output section (speaker) of the robot motion mechanism 32. When the presentation information indicates the emotional state of the robot 1, the robot control section 30 controls an actuator of each joint mechanism of the robot motion mechanism 32, or causes the LED to be turned ON, for example.

The robot-mounted sensor 34 is a touch sensor, a speech sensor (microphone), an imaging sensor (camera), or the like. The robot 1 can monitor the reaction of the user to the information presented to the user based on the sensor information from the robot-mounted sensor 34.

The communication section 40 transmits and receives information (e.g., user information) to and from the communication section 138-1 of the portable electronic instrument 100-1 and the communication section 138-2 of the portable electronic instrument 100-2 via wireless or cable communication.

The processing section 10 includes a user information acquisition section 12, a calculation section 13, and a presentation information determination section 14. Note that the processing section 10 may have a configuration in which some of these sections are omitted.

The user information acquisition section 12 acquires the user information based on the sensor information from at least one of the behavior sensor that measures the behavior of the user, the condition sensor that measures the condition of the user, and the environment sensor that measures the environment of the user.

For example, the user information update section 114-2 of the portable electronic instrument 100-2 updates the second user information (second user historical information) about the second user (e.g., a child, wife, lover, or the like of the first user) based on the sensor information from the wearable sensor 150-2. The updated second user information is stored in the user information storage section 122-2.

The second user information (second user historical information) stored in the user information storage section 122-2 is transferred to the user information storage section 22 of the robot 1 through the communication sections 138-2 and 40. Specifically, when the second user has returned home and approached the robot 1, or connected the portable electronic instrument 100-2 to a cradle so that a communication path has been established between the portable electronic instrument 100-2 and the robot 1, the second user information is transferred to the user information storage section 22 from the user information storage section 122-2. The user information acquisition section 12 reads the second user information transferred to the user information storage section 22 from the user information storage section 22 to acquire the second user information. Note that the user information acquisition section 12 may directly acquire the second user information from the portable electronic instrument 100-2 instead of reading the second user information from the user information storage section 22.

The user information update section 114-1 of the portable electronic instrument 100-1 updates the first user information (first user historical information) about the first user based on the sensor information from the wearable sensor 150-1. The updated first user information is stored in the user information storage section 122-1.

The first user information (first user historical information) stored in the user information storage section 122-1 is transferred to the user information storage section 22 (user information storage section 72) of the robot 1 through the communication sections 138-1 and 40. Specifically, when the first user has returned home and approached the robot 1, or connected the portable electronic instrument 100-1 to a cradle so that a communication path has been established between the portable electronic instrument 100-1 and the robot 1, the first user information is transferred to the user information storage section 22 from the user information storage section 122-1. The user information acquisition section 12 reads the first user information transferred to the user information storage section 22 from the user information storage section 22 to acquire the first user information. Note that the user information acquisition section 12 may directly acquire the first user information from the portable electronic instrument 100-1 instead of reading the first user information from the user information storage section 22.

The calculation section 13 performs a calculation process on the acquired user information. Specifically, the calculation section 13 performs an analysis process or a filtering process on the user information, if necessary. When the user information is the primary sensor information or the like, the calculation section 13 performs the calculation process shown by the expressions (1) and (2) to implement a filtering process that removes unnecessary sensor information from the acquired sensor information, an analysis process that determines the behavior, the condition, and the environment (TPO information) of the user based on the sensor information, and the like.

The presentation information determination section 14 determines the presentation information (conversation, emotional expression, and behavioral expression) that is presented (provided) to the user by the robot 1 based on the acquired user information (user information subjected to the calculation process).

Specifically, the presentation information determination section 14 determines the presentation information (phrase, emotional expression, or behavioral expression) presented to the first user based on the acquired second user information about the second user. The robot control section 30 causes the robot 1 to present the presentation information determined based on the second user information to the first user. For example, when the first user has approached the robot 1, the presentation information determination section 14 determines the presentation information based on the second user information about the second user who is positioned away from the robot 1, for example, and the determined presentation information is presented to the first user.

When the first user information about the first user has been acquired by the user information acquisition section 12, the presentation information determination section 14 may determine the presentation information presented to the first user based on the first user information and the second user information.

Specifically, the presentation information determination section 14 estimates the TPO (time, place and occasion) of the first user based on the first user information to acquire TPO information. Specifically, the presentation information determination section 14 acquires time information, and place information and occasion information abut the first user. The presentation information determination section 14 determination the presentation information based on the TPO information about the first user and the second user information about the second user.

More specifically, the presentation information determination section 14 determines the presentation timing of the presentation information (conversation start timing or speak timing) based on the first user information (TPO information), and determines the content of the presentation information (conversation or scenario data) based on the second user information. The robot control section 30 causes the robot 1 to present the presentation information having the determined content to the first user at the determined presentation timing.

Specifically, when the presentation information determination section 14 has determined that the presentation timing of the presentation information has not been reached (e.g., the first user is busy or does not have a mental leeway) based on the first user information (TPO of the first user), the robot control section 30 does not cause the robot 1 to present the presentation information. On the other hand, when the presentation information determination section 14 has determined that the presentation timing of the presentation information has been reached (e.g., the first user has a temporal leeway or has much time) based on the first user information, the presentation information determination section 14 determines the content of the presentation information based on the second user information, and the robot control section 30 causes the robot 1 to present information that indicates the condition, behavior, etc. of the second user to the first user.

This makes it possible to notify the first user of the condition etc. of the second user at an appropriate and timely timing so that more natural and smoother information presentation can be implemented.

When the user information acquisition section 12 has acquired the second user historical information (i.e., at least one of the behavior history, condition history, and environment history of the second user) as the second user information, the presentation information determination section 14 determines the presentation information that is presented to the first user by the robot 1 based on the acquired second user historical information. In this case, the second user historical information is information that is obtained as a result of an update process performed by the portable electronic instrument 100-2 or the like based on the sensor information from the wearable sensor 150-2 of the second user, for example, and transferred to the user historical information storage section 23 of the robot 1 from the user information storage section 122-2 of the portable electronic instrument 100-2. The behavior history, condition history, and environment history of the user may be information (log information) that indicates the behavior (e.g., walking, speech, or meal), the condition (e.g., tiredness, tension, hungry, mental condition, or physical condition), and the environment (e.g., place, brightness, or temperature) of the user, and is linked to the date and the like.

The presentation information determination section 14 determines the presentation information that is subsequently presented to the first user by the robot 1 based on the first reaction of the user to the presentation information that has been presented by the robot 1. Specifically, when the robot 1 has presented the presentation information to the first user and the first user has reacted to the presentation information, the reaction of the first user is detected by the robot-mounted sensor 34. The presentation information determination section 14 determines (estimates) the reaction of the first user based on the sensor information from the robot-mounted sensor 34, and determines the presentation information that is subsequently presented to the first user.

4. Operation

An operation according to this embodiment is described below. A conversation between the user and a robot is normally implemented by a one-to-one relationship (e.g., one user and one robot). In this case, the conversation between the user and the robot may become monotonous so that the user may lose interest in the conversation.

According to this embodiment, the robot that talks to the first user speaks based on the second user information about the second user different from the first user. Therefore, the first user can be notified of the information about the second user (e.g., family, friend, or lover of the first user) through communication with the robot. This prevents a situation in which a conversation with the robot becomes monotonous, so that a robot that can attract the user can be implemented.

In this case, the information presented to the user through a conversation with the robot is based on the second user information acquired based on the sensor information from the behavior sensor, the condition sensor, and the environment sensor included in the wearable sensor or the like. Therefore, the first user can be indirectly notified of the behavior, the condition, and the environment of the second user who is close to the first user through a conversation with the robot. For example, when a father always comes home late and cannot communicate with his child, the father can be indirectly notified of the situation of his child through a conversation with the robot. Moreover, the user can be indirectly notified of the behavior of his friend or lover who lives far away through a conversation with the robot. This makes it possible to provide a robot that serves as a novel communication means.

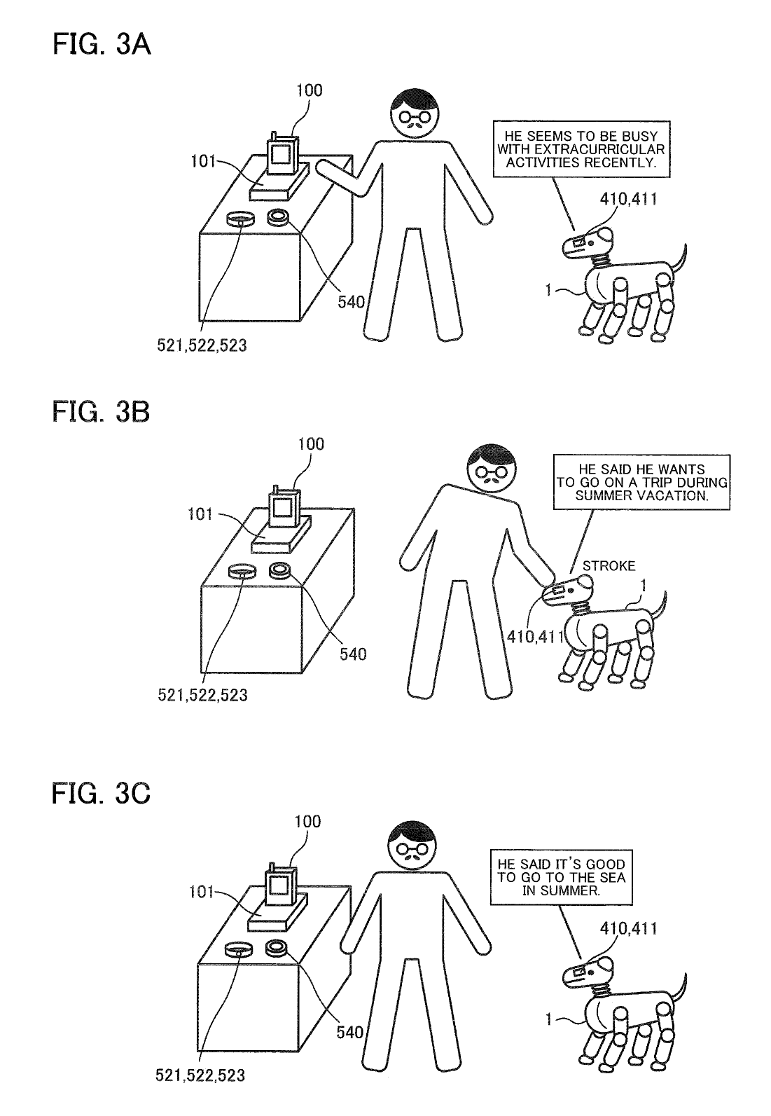

In FIG. 3A, the first user (father) who has returned home has connected the portable electronic instrument 100 (100-1) to a cradle 101 to charge the portable electronic instrument 100, for example. In FIG. 3A, when the portable electronic instrument 100 has been connected to the cradle 101, the robot control system determines that an event that makes the robot 1 available (available event) has occurred, and activates the robot 1. Note that the robot control system may activate the robot 1 when the robot control system has determined that the first user has approached the robot 1 instead of connection of the portable electronic instrument 100 to the cradle 101. For example, when information is transferred between the portable electronic instrument 100 and the robot 1 via wireless communication, occurrence of an event that makes the robot 1 available may be determined by detecting the radio signal strength.

When the available event has occurred, the robot 1 is activated and can be utilized. In this case, the second user information about the second user (child) has been stored in the user information storage section 22 of the robot 1. Specifically, information (e.g., behavior, condition, and environment) about the second user at the school and the like has been transferred and stored as the second user information. This makes it possible to control the operation (e.g., conversation) of the robot 1 based on the second user information. Note that the second user information may be collected and acquired through a conversation between the second user (child) and the robot 1.

In FIG. 3A, when the father (first user) has returned home from the office and approached the robot 1, the robot 1 starts to speak about the child (second user), for example. Specifically, the robot 1 speaks a phrase “He seems to be busy with extracurricular activities recently” to notify the father of the today's behavior of his child.

In FIG. 3B, the robot 1 speaks a phrase “He said he wants to go on a trip during summer vacation” to notify the father of child's wishes acquired through a conversation with the child. In FIG. 3B, the father who is interested in the child's wishes strokes the robot 1. Specifically, since the father wants to know the details of the child's wishes, he requests the robot 1 to provide more information by stroking the robot 1. As shown in FIG. 3C, the robot 1 speaks a phrase “He said it's good to go to the sea in summer” based on the information collected from the child. The father can thus be notified that his child wants to go to the sea during summer vacation. In FIG. 3B, the phrase that is subsequently spoken by the robot 1 (presentation information that is subsequently presented) is determined based on the reaction (stroke operation) of the father (first user) to the phrase spoken by the robot 1 (presentation information presented by the robot).

For example, a father who returns home late every day does not have enough time to have a conversation with his child, and cannot easily know his child's behavior and wishes. Even if the father has time to have a conversation with his child, the child may not directly tell his wishes to his father.

According to this embodiment, indirect communication between the father and his child is implemented through the robot 1. For example, even if the child does not directly tell his wishes to his father, the father can be smoothly notified of his child's wishes through the robot 1. When the child involuntarily told his wishes to the robot 1, the father can be notified of his child's wishes.

It is also possible to prompt the father who does not have enough time to have a conversation with his child and has lost interest in his child to be aware of something about his child. This makes it possible to implement an inspiring ubiquitous service that prompts the user to become aware of something through a conversation with the robot 1, instead of a convenience provision service.

When an event that makes the robot 1 available has occurred and the robot 1 has been activated (see FIG. 3A), the first user information (i.e., the user information about the father) may be transferred to and stored in the user information storage section 22 of the robot 1. Specifically, the information about the behavior, condition, environment, etc. of the father in the office etc. is transferred to and stored in the user information storage section 22 of the robot 1. This makes it possible to control a conversation of the robot 1 and the like using the first user information about the father and the second user information about the child.

For example, it is determined that the father has returned home later than usual based on the first user information. Specifically, the time when the father returns home (“return home time”) is measured every day based on the place information from the GPS sensor of the wearable sensor and the time information from a timer. The average return home time in the past is compared with the current return home time to determine whether or not the father has returned home later than usual.

When the father has returned home considerably later than usual, it is estimated that the father is very tired due to work or the like. In this case, the robot 1 does not immediately speak to the father about the child, but speaks am appreciation phrase (e.g., “You worked hard today”). Alternatively, the robot 1 speaks to the father about the game result of his favorite baseball team, for example.

After the farther has felt refreshed, the robot 1 starts to talk about the child based on the second user information. Specifically, the weighting of the first user information (first user historical information) and the weighting of the second user information (second historical information) when determining the presentation information (conversation) are changed with the passage of time. More specifically, the presentation information is determined while increasing the weighting of the first user information (i.e., the user information about the father) and decreasing the weighting of the second user information (i.e., the user information about the child) when an event that makes the robot 1 available has occurred. The presentation information is then determined while decreasing the weighting of the first user information and increasing the weighting of the second user information. This implements timely information presentation appropriate for the TPO of the father.

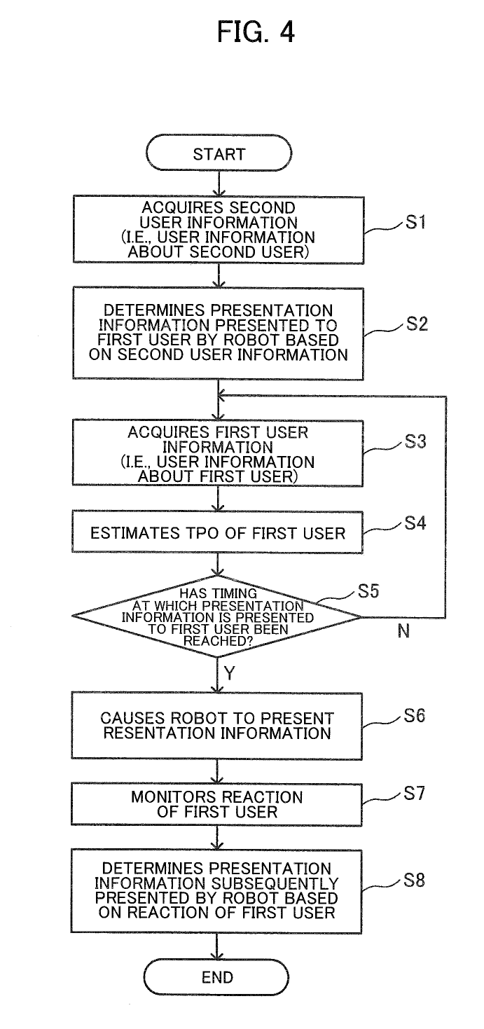

FIG. 4 is a flowchart illustrative of the operation according to this embodiment.

The user information acquisition section 12 acquires the second user information (i.e., the user information about the second user (child)) (step S1). Specifically, the second user information is transferred from the portable electronic instrument 100-2 of the second user to the user information storage section 22, and the second user information is read from the user information storage section 22. The robot 1 determines the content of the presentation information (e.g., conversation) presented to the first user (father) based on the acquired second user information (i.e., the user information about the child) (step S2).

The user information acquisition section 12 then acquires the first user information (i.e., the user information about the first user (father)) (step S3). Specifically, the first user information is transferred from the portable electronic instrument 100-1 of the first user to the user information storage section 22, and the first user information is read from the user information storage section 22. The TPO of the first user is optionally estimated based on the first user information (step S4). The TPO (time, place, and occasion) information is at least one of the time information (e.g., year, month, week, day, and time), the place information (e.g., place, position, and distance) about the user, and the occasion (condition) information (e.g., mental/physical condition and event that has occurred). For example, the meaning of latitude/longitude information obtained by the GPS sensor differs depending on the user. If the latitude and the longitude indicate the home of the user, the user is estimated to stay at home.

Whether or not the timing at which the presentation information is presented to the first user has been reached is determined based on the first user information (TPO of the first user) (step S5). For example, when it has been determined that the first user is busy or is tired based on the first user information, it is determined that the presentation timing has not been reached, and the process returns to the step S3.

When it has been determined that the timing at which the presentation information is presented to the first user has been reached, the robot 1 is caused to present the presentation information (step S6). Specifically, the robot 1 is caused to speak a phrase (see FIGS. 3A to 3C).

The reaction of the first user to the presentation information presented in the step S6 is monitored (step S7). For example, whether the first user has stroked the robot 1, has hit the robot 1, or has done nothing is determined. The presentation information that is subsequently presented by the robot 1 is determined based on the reaction of the first user that has been monitored (step S8). Specifically, the phrase that is subsequently spoken by the robot 1 is determined.

5. A Plurality of Robots

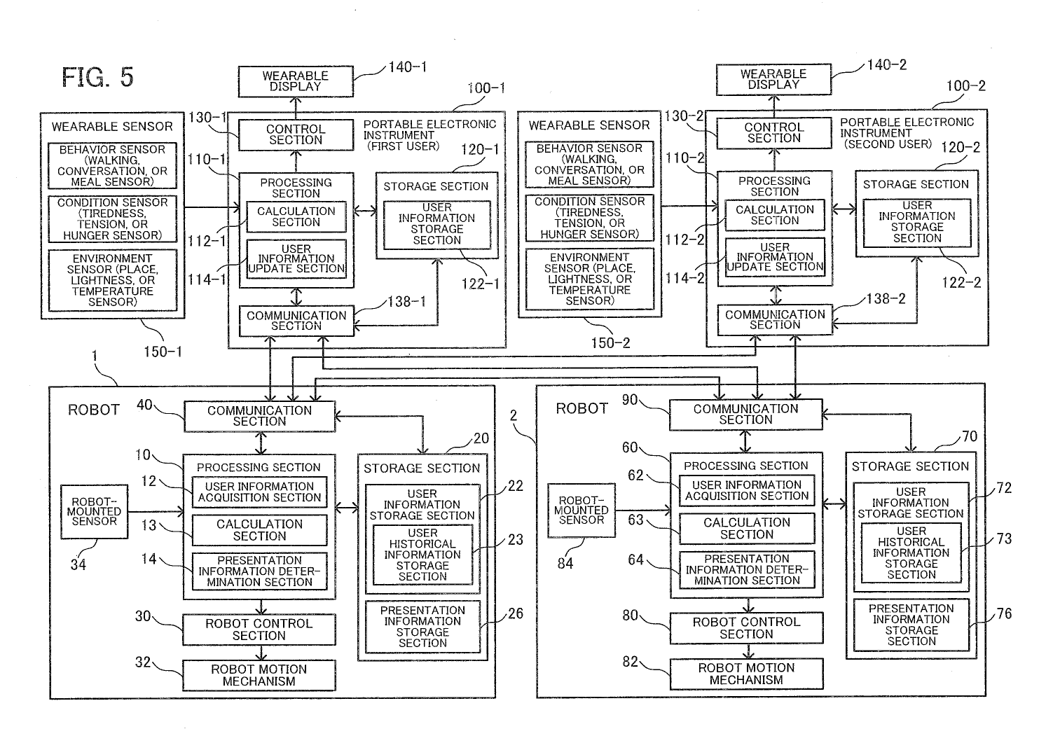

An example in which one robot is used for a plurality of users has been described above. Note that this embodiment is not limited thereto. This embodiment may also be applied to the case where a plurality of robots are used for a plurality of users. FIG. 5 shows a second system configuration example according to this embodiment in which a plurality of robots are used.

The system shown in FIG. 5 includes the portable electronic instruments 100-1 and 100-2 respectively carried by the first user and the second user, and the robots 1 and 2 (first robot and second robot) that are controlled by the robot control system according to this embodiment. The robot control system is implemented by the processing sections 10 and 60 included in the robots 1 and 2, for example. The configuration of the robot 2 is the same as that of the robot 1. Therefore, description thereof is omitted.

In FIG. 5, the presentation information determination section 14 (64) determines the presentation information (phrase) presented to the first user so that the robots 1 and 2 present different types of presentation information (different phrases, different emotional expressions, or different behavioral expressions) based on the identical acquired second user information. For example, the presentation information determination section 14 determines the presentation information so that the robot 1 presents first presentation information (first phrase) and the robot 2 presents second presentation information (second phrase) that differs from the first presentation information based on the acquired second user information.

An operation of the second system configuration example shown in FIG. 5 is described below. A conversation between the user and the robot is normally implemented by a one-to-one relationship (e.g., one user and one robot).

In FIG. 5, however, two robots 1 and 2 (a plurality of robots in a broad sense) are provided. The user listens to a conversation between the robots 1 and 2 instead of directly having a conversation with the robots 1 and 2.

This makes it possible to implement an inspiring ubiquitous service that appeals to the user's mind through a conversation between the robots 1 and 2 to prompt the user to become aware of the behavior, condition, and environment of the user for further personal growth, instead of a convenience provision service that externally and unilaterally presents information to the user.

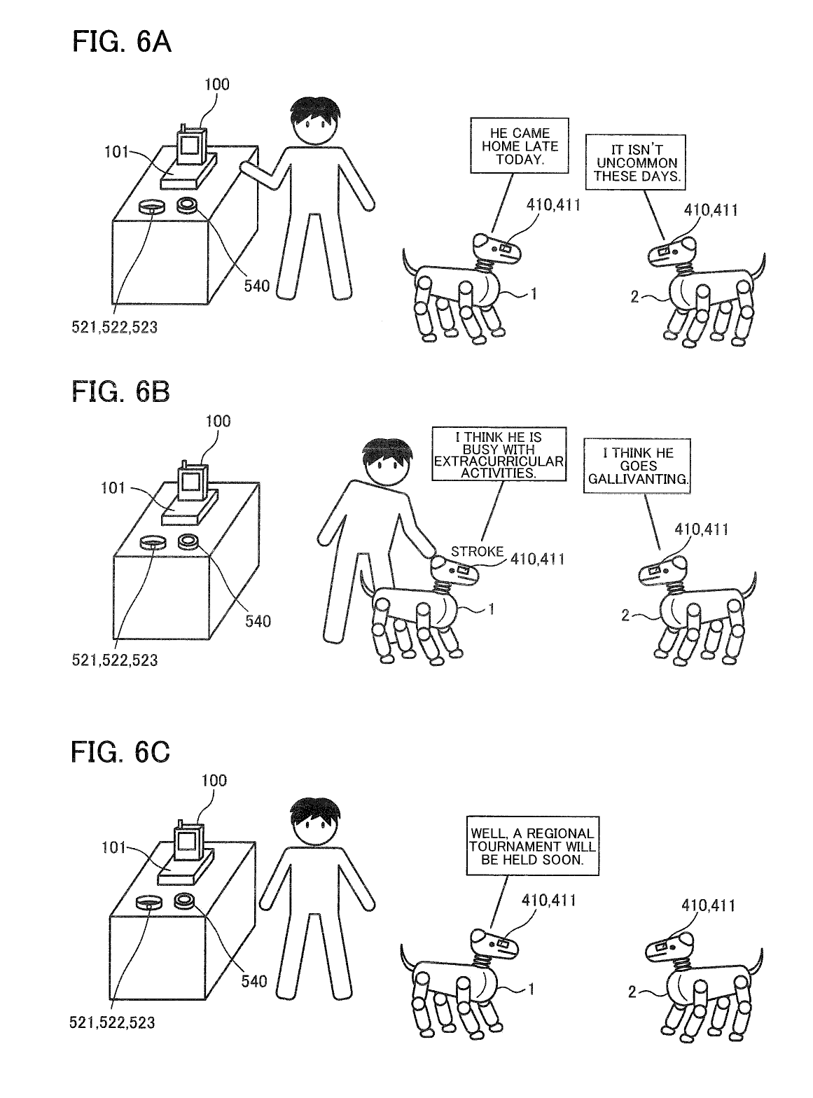

FIGS. 6A to 6C show an example of acquiring the second user information about the second user (i.e., child). In FIG. 6A, the child who has returned home has connected the portable electronic instrument 100 (100-2) to the cradle 101 to charge the portable electronic instrument 100, for example. In FIG. 6A, when the portable electronic instrument 100 has been connected to the cradle 101, the robot control system determines that an event that makes the robots 1 and 2 available has occurred, and activates the robots 1 and 2. Note that the robot control system may determine that the child has approached the robots 1 and 2 by detecting the radio signal strength to activate the robots 1 and 2.

When the robots 1 and 2 have been activated, the second user information stored in the portable electronic instrument 100 carried by the child is transferred to the user information storage sections 22 and 72 of the robots 1 and 2. A conversation between the robots 1 and 2 and the like is controlled based on the second user information about the child that has been updated in the mobile environment. The second user information updated in the mobile environment is further updated in the home environment based on a conversation with the robots 1 and 2, for example.

In FIG. 6A, it is determined that the child has returned home later than usual based on the second user information. When it has been determined that the child has returned home later than usual, presentation information relating to the return home time of the child is presented by the robots 1 and 2. Specifically, scenario data concerning the return home time of the child is selected, and the robots 1 and 2 start a conversation based on the selected scenario data. In FIG. 6A, the robot 1 speaks a phrase “He came home late today!”, and the robot 2 speaks a phrase “It isn't uncommon these days”, for example.

In FIG. 6B, the robot 1 speaks a phrase “I think he is busy with extracurricular activities”, and the robot 2 speaks a phrase “I think he goes gallivanting”. Specifically, the robots 1 and 2 present different types of presentation information based on the identical second user information (i.e., came home later than usual). The child strokes the robot 1 that has spoken the phrase “I think he is busy with extracurricular activities”, since the child was busy with extracurricular activities and could not come home as usual. The robot 1 that has been stroked then speaks a phrase “Well, a regional tournament will be held soon” (see FIG. 6C).

In this case, the second user information is updated based on the reaction (stroke operation) of the child to the contrasting phrases spoken by the robots 1 and 2 (see FIG. 6B). Specifically, it is estimated that the child has come home late due to extracurricular activities. This estimation is recorded as the second user information, and scenario data presented to the father is created. That is, the scenario data presented to the father (first user) is created based on the reaction of the child (second user) to the phrases spoken by the robots 1 and 2.

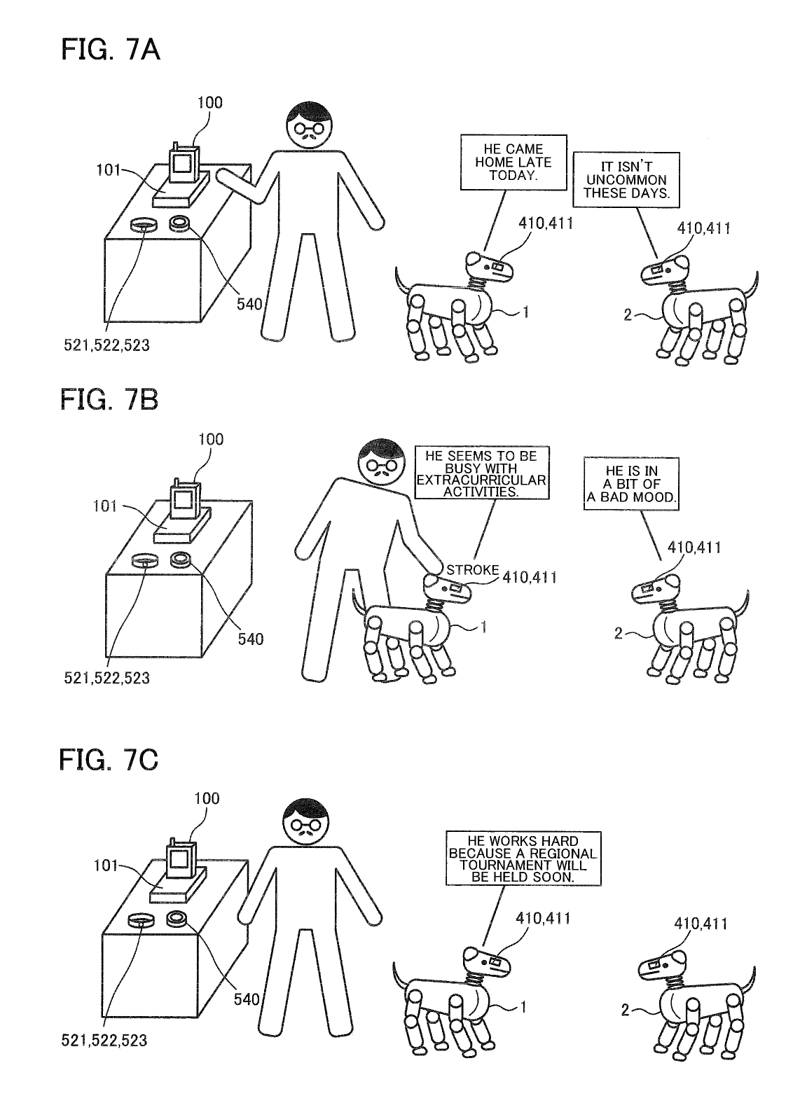

FIGS. 7A to 7C show an example when the father (first user) has returned home after the child.

When it has been detected that the father has returned home and connected the portable electronic instrument 100 (100-1) to the cradle 101, for example, the robots 1 and 2 are activated. The second user information that has been updated by the conversation with the child (see FIGS. 6A to 6C) has been stored in the user information storage sections 22 and 72 of the robots 1 and 2. A conversation between the robots 1 and 2 is controlled based on the second user information, for example. Specifically, scenario data concerning the late return home time of the child is selected, and the robots 1 and 2 start a conversation based on the selected scenario data. In FIG. 7A, the robot 1 speaks a phrase “He came home late today”, and the robot 2 speaks a phrase “It isn't uncommon these days”, for example.

In this case, the presentation information that is presented to the father (first user) by the robots 1 and 2 is determined so that the robots 1 and 2 present different types of presentation information based on the identical second user information (i.e., the child came home later than usual). In FIG. 7B, the robot 1 speaks a phrase “He seems to be busy with extracurricular activities”, and the robot 2 speaks a phrase “He is in a bit of a bad mood”.

For example, if the robot necessarily speaks a similar phrase to the user, the user may lose interest or get stuck in the conversation with the robot.

In FIG. 7B, however, the robots 1 and 2 speak phrases that make a contrast with each other. Moreover, the robots 1 and 2 have a conversation instead of directly talking to the user, and the user listens to the conversation between the robots 1 and 2. This makes it possible to provide an inspiring ubiquitous service that prompts the user to become aware of something through the conversation between the robots 1 and 2, instead of a convenience provision service.

In FIG. 7B, the father strokes the robot 1 since he is interested in the extracurricular activities of the child rather than the child's mood today. The reaction (stroke operation) of the user to the phrases spoken by the robots 1 and 2 is detected by the touch sensor 410 of the robot 1, for example.

Then, the phrases subsequently spoken to the father by the robots 1 and 2 (i.e., presentation information subsequently presented to the father) are determined based on the reaction (i.e., stroke operation) of the user. Specifically, the robot 1 that has been stroked speaks a phrase “He works hard because a regional tournament will be held soon” (see FIG. 7C). The robots 1 and 2 then have a conversation based on a scenario regarding the extracurricular activities of the child.

In FIGS. 6A to 6C, the second user information (i.e., the user information about the child) is updated through the conversation between the robots 1 and 2, and the scenario data presented to the father is created. Therefore, the second user information is automatically collected and acquired without being noticed by the child. The scenario data regarding the child is created based on the acquired second user information, and presented to the father through the conversation between the robots 1 and 2 (see FIGS. 7A to 7C). Therefore, indirect communication between the father and his child can be implemented through the robots 1 and 2. This makes it possible to implement an inspiring ubiquitous service that prompts the user to become aware of something through a conversation with a robot.

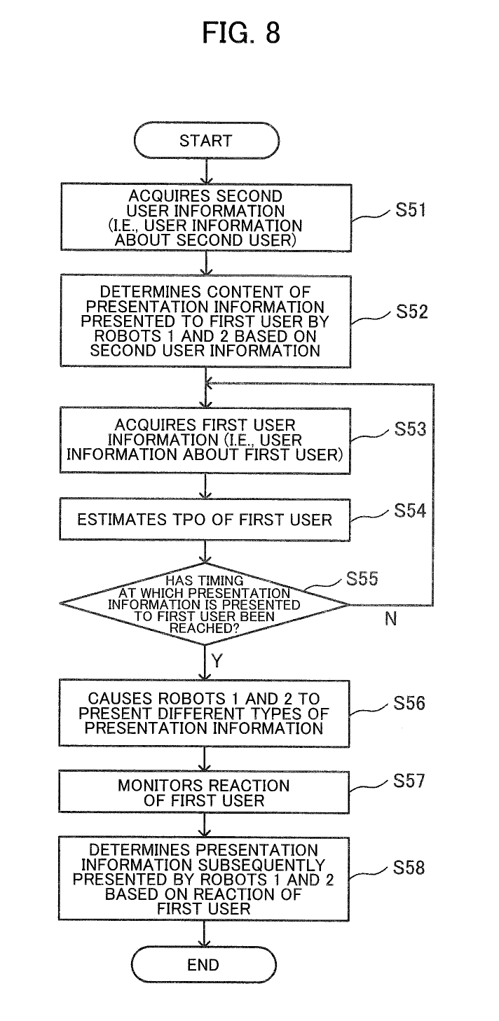

FIG. 8 is a flowchart illustrative of the operation of the system shown in FIG. 5. FIG. 8 differs from FIG. 4 as to the process in a step S56. Specifically, when it has been determined that the timing at which the presentation information is presented to first user (father) has been reached (step S55), the robots 1 and 2 are caused to present different types of presentation information in the step S56. Specifically, the phrases spoken by the robots 1 and 2 are determined so that the robots 1 and 2 speak different phrases based on the second user information (i.e., the return home time of the child) (see FIGS. 7A to 7C). This prevents a situation in which a conversation between the user and the robot becomes monotonous.

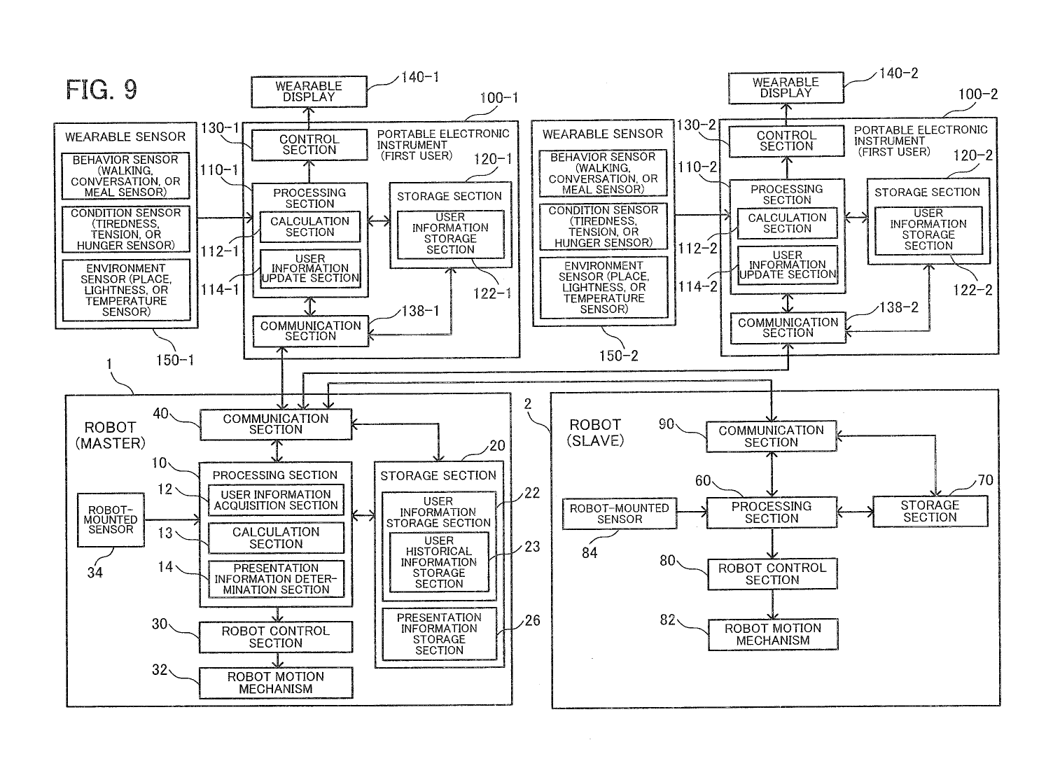

FIG. 9 shows a third system configuration example (modification of FIG. 5). In FIG. 9, the robot 1 is set as a master, and the robot 2 is set as a slave. The robot control system is mainly implemented by the processing section 10 of the master-side robot 1.

Specifically, the user information acquisition section 12 of the master-side robot 1 acquires the user information (second user information), and the master-side presentation information determination section 14 determines the presentation information that is presented to the user by the robots 1 and 2 based on the acquired user information. For example, when the presentation information determination section 14 has determined that the master-side robot 1 presents first presentation information and the slave-side robot presents second presentation information, the master-side robot control section 30 causes the robot 1 to present the first presentation information. The master-side robot 1 is thus controlled. The master-side presentation information determination section 14 instructs the slave-side robot 2 to present presentation information to the user. For example, when the master-side robot 1 presents first presentation information and the slave-side robot 2 presents second presentation information, the master-side presentation information determination section 14 instructs the slave-side robot 2 to present the second presentation information. The slave-side robot control section 80 then causes the robot 2 to present the second presentation information. The slave-side robot 2 is thus controlled.

In this case, the communication section 40 transmits instruction information that instructs the slave-side robot 2 to present the presentation information from the master-side robot 1 to the slave-side robot 2 via wireless communication or the like. When the slave-side communication section 90 has received the instruction information, the slave-side robot control section 80 causes the robot 2 to present the presentation information indicated by the instruction information.

The presentation information instruction information is an identification code of the presentation information, for example. When the presentation information indicates a phrase in a scenario, the instruction information is a data code of the phrase in the scenario.

For example, when the robots 1 and 2 have a conversation, the robot 2 may identify the phrase spoken by the robot 1 by voice recognition, and speak a phrase based on the voice recognition result.

However, this method requires a complex voice recognition/analysis process so that an increase in cost of the robot and complexity of the process, a malfunction, and the like may occur.

In FIG. 9, a conversation between the robots 1 and 2 is implemented under control of the master-side robot 1. Specifically, although the user observes a situation in which the robots 1 and 2 have a conversation while recognizing words spoken by the other, the robots 1 and 2 actually have a conversation under control of the master-side robot 1. Since the slave-side robot 2 determines the presentation information based on the instruction information transmitted from the master-side robot 1, it is unnecessary to utilize a voice recognition process. Therefore, a conversation between the robots 1 and 2 can be implemented under stable control (i.e., malfunctions rarely occur) without utilizing a complex voice recognition process or the like.

6. Acquisition of Second User Information Through Network

A case where the method according to this embodiment is applied to family communication has been mainly described above. Note that this embodiment is not limited thereto. For example, the method according to this embodiment may also be applied to communication between users (e.g., friends, lovers, or relatives who live in places apart from each other).

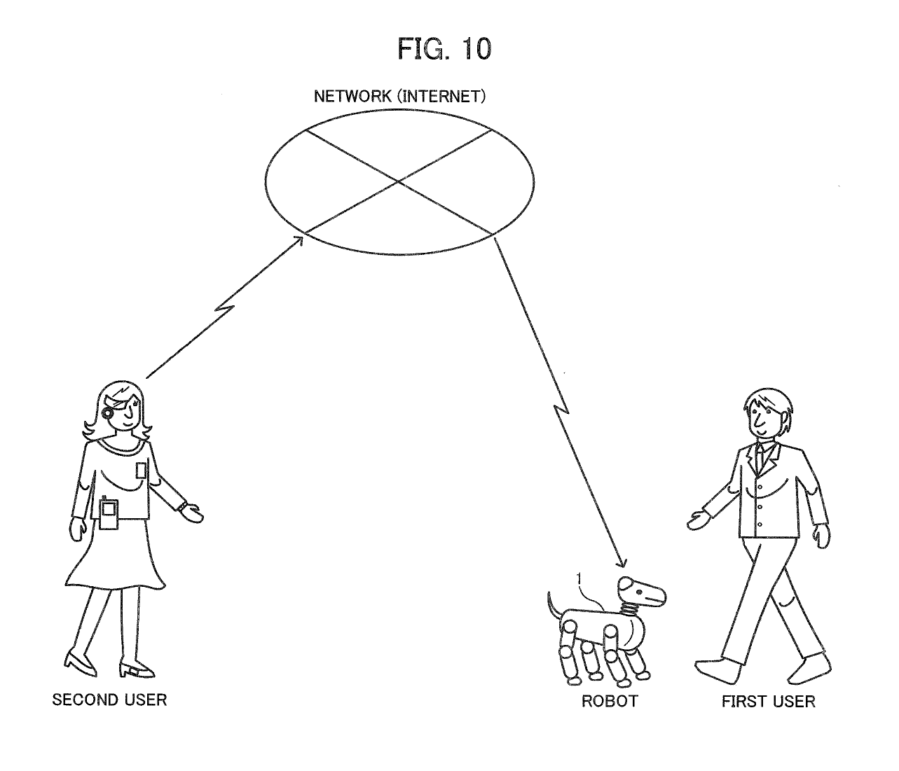

In FIG. 10, second user information about a second user who is a girlfriend of the first user is acquired, for example. Specifically, the second user information (second user historical information) is updated by the method described with reference to FIG. 1 etc. in the mobile environment or the home environment of the second user. The updated second user information is transmitted through a network (e.g., the Internet). Specifically, the user information acquisition section 12 of the robot 1(robot control system) acquires the second user information through the network. The presentation information determination section 14 determines the presentation information presented to the first user based on the second user information acquired through the network.

This allows the first user to be notified of the behavior, condition, environment (behavior history, condition history, or environment history), etc. of the second user who is situated at a distance apart from the first user through the robot 1. Specifically, the robot 1 (or the robots 1 and 2) speaks as described with reference to FIGS. 3A to 3C based on the scenario data based on the second user information acquired through the network. Therefore, the first user can be indirectly notified of the state (situation) of the second user (girlfriend) through the conversation with the robot 1. This implements indirect communications between the first user and the second user who is situated at a distance apart from the first user to provide a novel communication means. In the system shown in FIG. 10, the second user information may be acquired without passing through the portable electronic instrument.

7. System Configuration Example

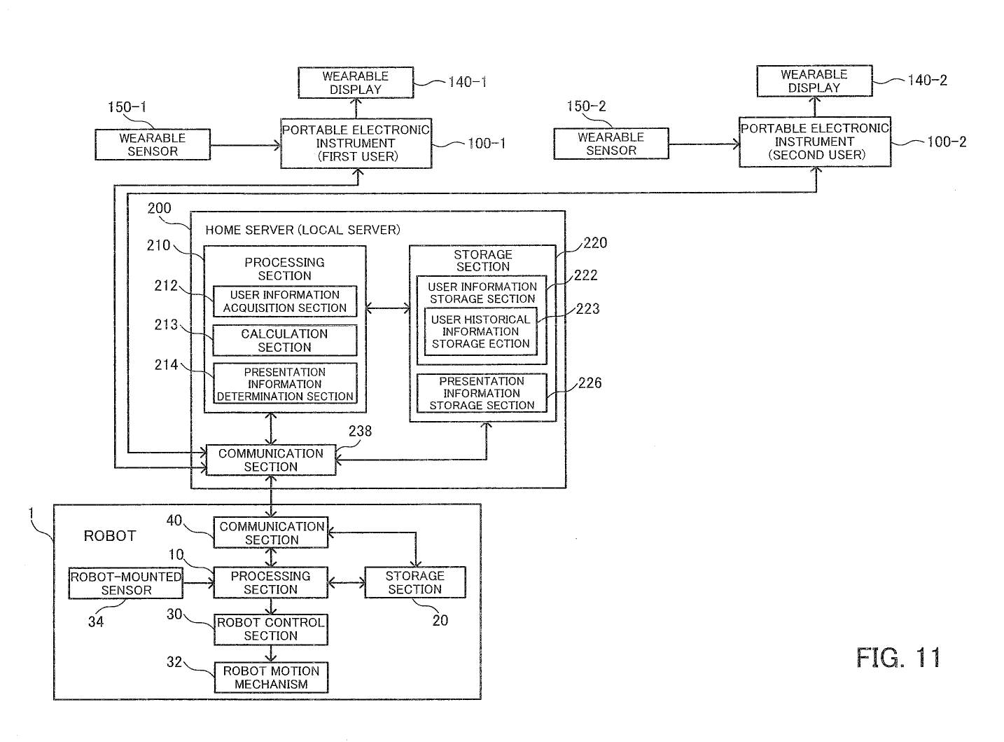

Another system configuration example according to this embodiment is described below. FIG. 11 shows a fourth system configuration example according to this embodiment. FIG. 11 shows an example in which one robot is provided. Note that a plurality of robots may be provided, as shown in FIG. 5.

In FIG. 11, a home server (local server) 200 is provided. The home server 200 controls a control target instrument of a home subsystem, or communicates with the outside, for example. The robot 1 (or the robots 1 and 2) operates under control of the home server 200.

In the system shown in FIG. 11, the portable electronic instruments 100-1 and 100-2 and the home server 200 are connected via a wireless LAN, a cradle, or the like, and the home server 200 and the robot 1 are connected via a wireless LAN or the like. The robot control system according to this embodiment is mainly implemented by the processing section 210 of the home server 200. Note that the process of the robot control system may be implemented by distributed processing of the home server 200 and the robot 1.

When the user (first or second user) who carries the portable electronic instrument 100-1 or 100-2 has approached home, the portable electronic instruments 100-1 and 100-2 can communicate with the home server 200 via a wireless LAN or the like. Alternatively, the portable electronic instruments 100-1 and 100-2 can communicate with the home server 200 when the user has placed the portable electronic instrument 100-1 or 100-2 on the cradle.

When a communication path has been established, the user information (first user information and second user information) is transferred from the portable electronic instruments 100-1 and 100-2 to a user information storage section 222 of the home server 200. A user information acquisition section 212 of the home server 200 then acquires the user information. A calculation section 213 performs necessary calculation processes, and a presentation information determination section 214 determines presentation information that is presented to the user by the robot 1. The presentation information or the presentation information instruction information (e.g., phrase speech instruction information) is transmitted from a communication section 238 of the home server 200 to the communication section 40 of the robot 1. The robot control section 30 of the robot 1 presents the received presentation information or the presentation information indicated by the received instruction information to the user.

According to the configuration shown in FIG. 11, since the robot 1 need not have a storage section that stores the user information and the presentation information when the user information and the presentation information (scenario data) have a large data size, for example, the cost and the size of the robot 1 can be reduced. Since the process of transferring and calculating the user information and the presentation information can be performed and managed by the home server 200, more intelligent robot control can be implemented.

According to the system shown in FIG. 11, the user information can be transferred from the portable electronic instruments 100-1 and 100-2 to the user information storage section 222 of the home server 200 before an event that makes the robot 1 available occurs. For example, the user information that has been updated in the mobile environment is transferred to and written the user information storage section 222 of the home server 200 before the user who returns home approaches the robot 1 (e.g., when the information from the GPS sensor (i.e., wearable sensor) worn by the user indicates that the user has arrived at the nearest station, or when the information from the door sensor (i.e., home sensor) indicates that the user has opened the front door). When the user who has approached the robot 1 (i.e., an event that makes the robot 1 available has occurred), the robot 1 is controlled based on the user information transferred in advance to the user information storage section 222. Specifically, the robot 1 is activated and caused to speak as shown in FIGS. 3A to 3C, for example. According to this configuration, a conversation based on the user information can be started immediately after activating the robot 1 so that the control efficiency can be improved.

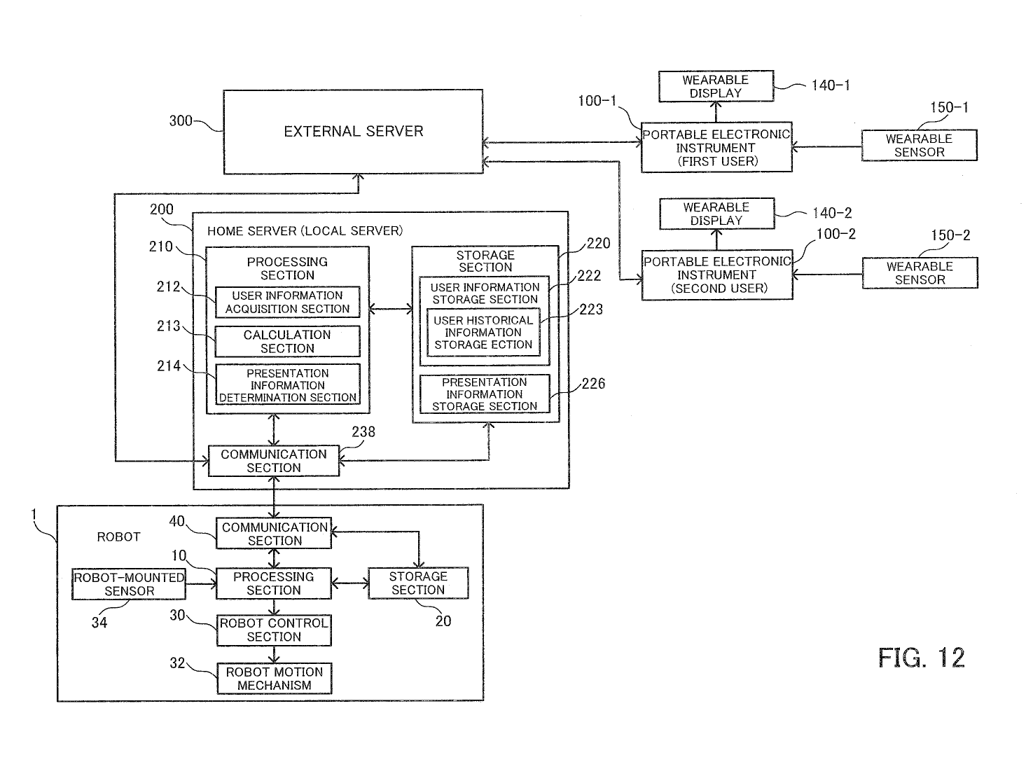

FIG. 12 shows a fifth system configuration example according to this embodiment. In FIG. 12, an external server (main server) 300 is provided. The external server 300 communicates with the portable electronic instruments 100-1 and 100-2 and the home server 200, and performs various control processes. FIG. 12 shows an example in which one robot is provided. Note that a plurality of robots may be provided (see FIG. 5).

In the system shown in FIG. 12, the portable electronic instruments 100-1 and 100-2 and the external server 300 are connected via a wireless WAN (e.g., PHS), the external server 300 and the home server 200 are connected via a cable WAN (e.g., ADS), and the home server 200 and the robot 1 (robots 1 and 2) are connected via a wireless LAN or the like. The robot control system according to this embodiment is mainly implemented by the processing section 210 of the home server 200 and a processing section (not shown) of the external server 300. Note that the process of the robot control system may be implemented by distributed processing of the home server 200, the external server 300, and the robot 1.

Each unit (e.g., the portable electronic instruments 100-1 and 100-2 and home server 200) appropriately communicates with the external server 300, and transfers the user information (first user information and second user information). Whether or not the user (first user and second user) has approached home is determined by utilizing the PHS position registration information, GPS sensor, microphone, and the like. When the user has approached home, the user information stored in a user information storage section (not shown) of the external server 300 is downloaded to the user information storage section 222 of the home server 200, and the robot 1 is controlled to present the presentation information. The scenario data described later or the like may also be downloaded from the external server 300 to a presentation information storage section 226 of the home server 200.

According to the system shown in FIG. 12, the user information and the presentation information can be integrally managed using the external server 300.

8. User Historical Information

A process of updating the user historical information (i.e., user information) and a specific example of the user historical information are described below. The user information may include user information that is obtained in real time based on the sensor information, user historical information that indicates the history of the user information that is obtained in real time based on the sensor information, and the like.

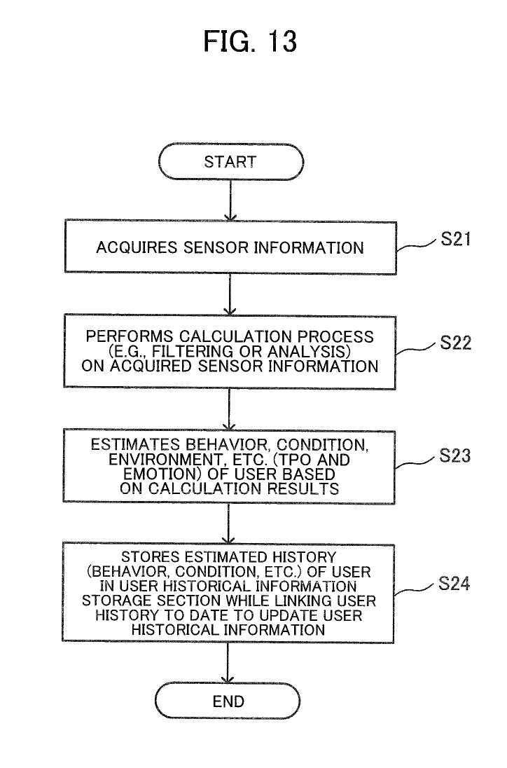

FIG. 13 is a flowchart showing an example of a user historical information update process.

The sensor information from the wearable sensor 150 and the like is acquired (step S21). A calculation process (e.g., filtering or analysis) is performed on the acquired sensor information (step S22). The behavior, condition, environment, etc. (TPO and emotion) of the user are estimated based on the calculation results (step S23). The estimated history (behavior, condition, etc.) of the user is stored in the user historical information storage section 23 (223) while linking the user history to the date (year, month, week, day, and time) to update the user historical information (step S24).

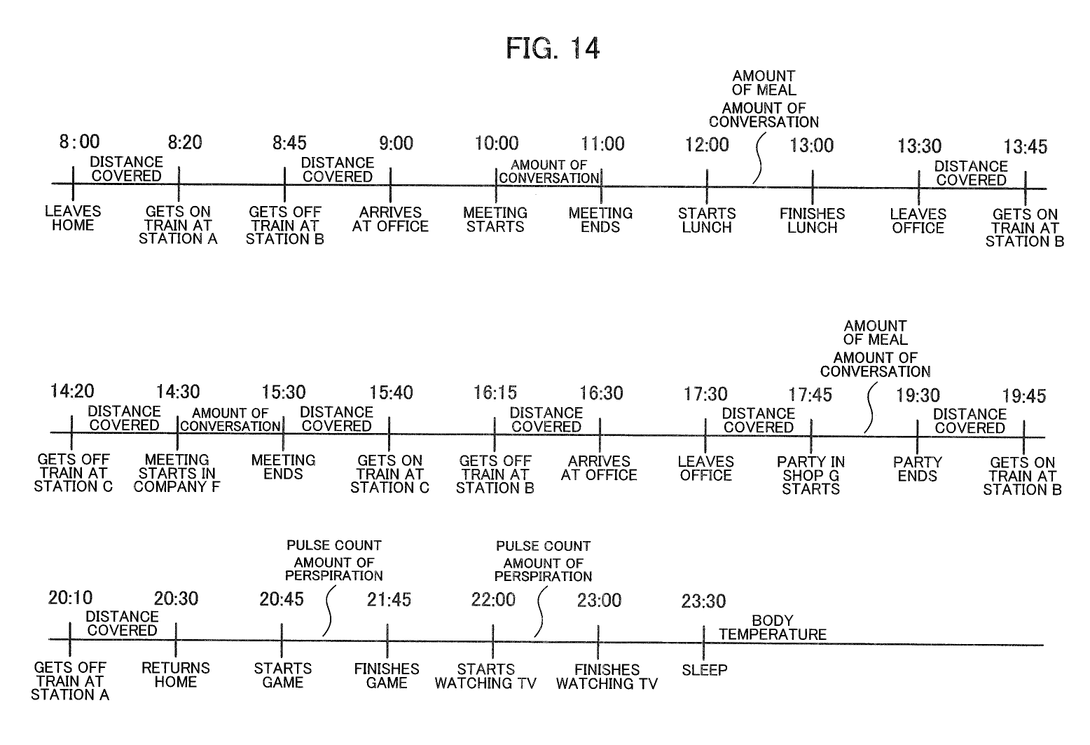

FIG. 14 schematically shows a specific example of the user historical information. The user historical information shown in FIG. 14 has a data structure in which the history (behavior etc.) of the user is linked to the time zone, time, etc. For example, the user leaves home at 8:00 AM, walks from home to the station in the time zone from 8:00 AM to 8:20 AM, and arrives at the nearest station A at 8:20 AM. The user takes a train in the time zone from 8:20 AM to 8:45 AM, gets off the train at a station B nearest to the office at 8:45 AM, arrives at the office at 9:00 AM, and starts working. The user holds a meeting with colleagues in the time zone from 10:00 AM to 11:00 AM, and has lunch in the time zone from 12:00 PM to 13:00 PM.

In FIG. 14, the user historical information is constructed by linking the history (behavior etc.) of the user estimated based on the sensor information and the like to the time zone, time, etc.

In FIG. 14, the values (e.g., amount of conversation, amount of meal, pulse count, and amount of perspiration) measured by the sensor and the like are also linked to the time zone, time, etc. For example, the user walks from home to the station A in the time zone from 8:00 AM to 8:20 AM. The distance covered by the user in the time zone is measured by the sensor, and linked to the time zone from 8:00 AM to 8:20 AM. In this case, a measured value indicated by the sensor information other than the distance covered (e.g., walking speed and amount of perspiration) may be further linked to the time zone. This makes it possible to determine the amount of exercise of the user etc. in the time zone.

The user holds a meeting with colleagues in the time zone from 10:00 AM to 11:00 AM. The amount of conversation in the time zone is measured by the sensor, and linked to the time zone from 10:00 AM to 11:00 AM. In this case, a measured value indicated by sensor information (e.g., voice condition and pulse count) may be further linked to the time zone. This makes it possible to determine the amount of conversation and the tension level of the user in the time zone.

The user plays a game and watches TV in the time zone from 20:45 to 21:45 and the time zone from 22:00 to 23:00. The pulse count and the amount of perspiration in these time zones are linked to these time zones. This makes it possible to determine the excitement level of the user etc. in these time zones.

The user sleeps in the time zone from 23:30. A change in body temperature of the user in the time zone is linked to the time zone. This makes it possible to determine the health condition of the user during sleep.

Note that the user historical information is not limited to that shown in FIG. 14. For example, the user historical information may be created without linking the history (behavior etc.) of the user to the date, time, etc.

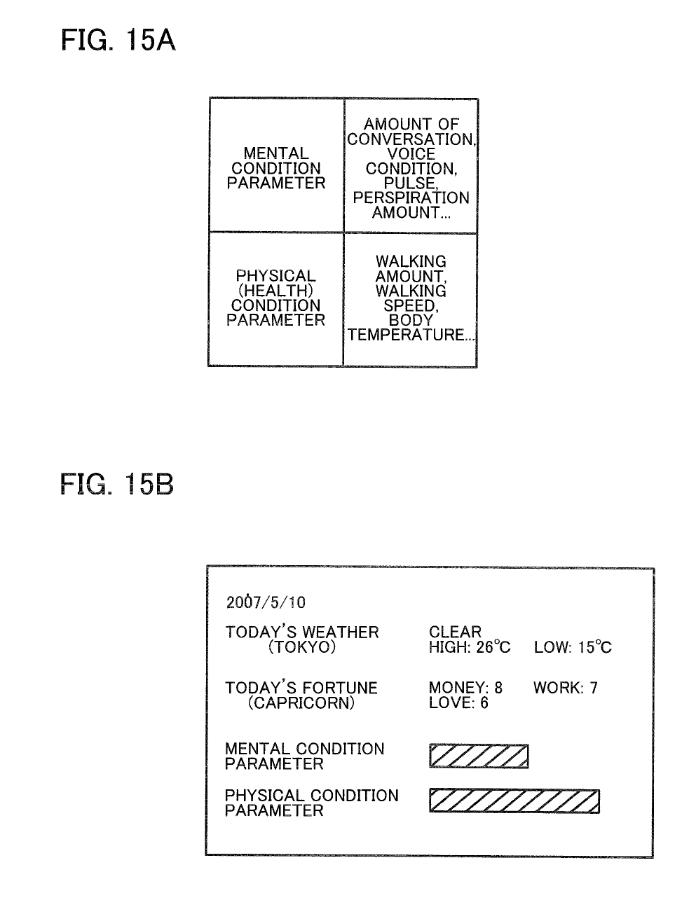

In FIG. 15A, mental condition parameters of the user are calculated by a given expression based on the measured values (e.g., amount of conversation, voice condition, pulse count, and amount of perspiration) indicated by the sensor information, for example. For example, the mental condition parameter increases (i.e., the user has a good mental condition) as the amount of conversation increases. Physical condition (health condition) parameters (exercise quantity parameters) are calculated by a given expression based on the measured values (e.g., walking amount, walking rate, and body temperature) indicated by the sensor information. For example, the physical condition parameter increases (i.e., the user has a good physical condition) as the walking amount increases.

As shown in FIG. 15B, the mental condition parameters and the physical condition parameters (condition parameters in a broad sense) may be visualized by utilizing a bar chart or the like, and displayed on the wearable display or the home display. The robot that operates in the home environment may be controlled to appreciate the pains the user has taken, encourage the user, or give the user advice based on the mental condition parameters and the physical condition parameters that have been updated in the mobile environment.

According to this embodiment, the user historical information (i.e., at least one of the behavior history, condition history, and environment history of the user) is acquired as the user information. The presentation information presented to the user by the robot is determined based on the acquired user historical information.

9. Conversation Between Robots Based on Scenario

A specific example of a case where a conversation between robots based on a scenario is presented to the user as the presentation information is described below.

9.1 Configuration

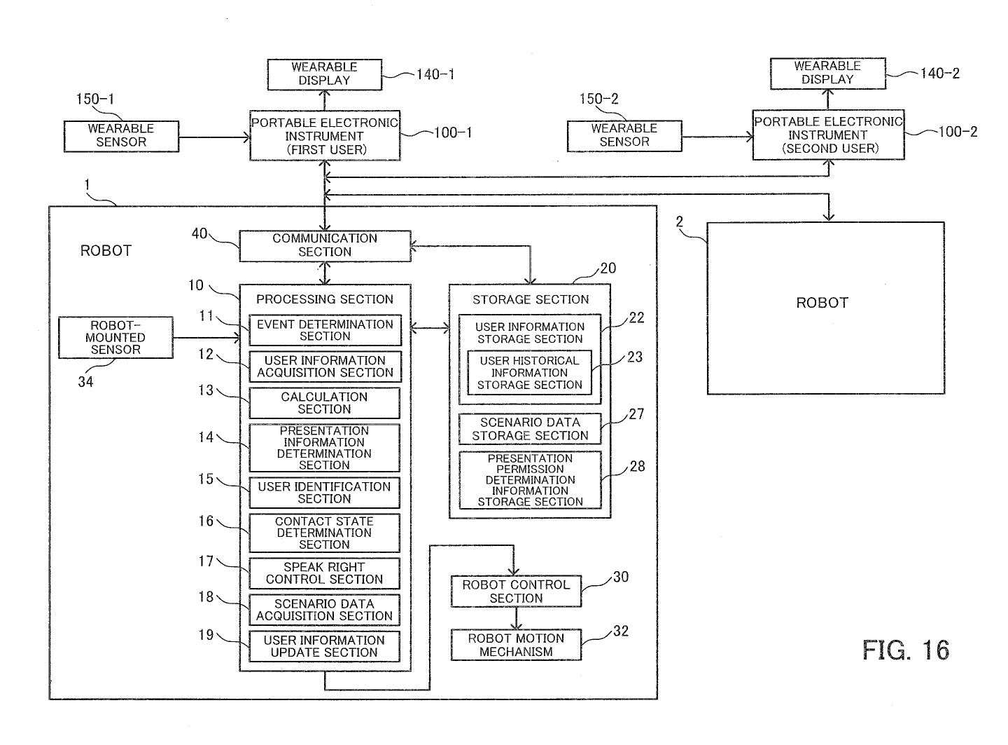

FIG. 16 shows a detailed system configuration example according to this embodiment. FIG. 16 differs from FIGS. 2 and 5, etc. in that the processing section 10 further includes an event determination section 11, a user identification section 15, a contact state determination section 16, a speak right control section 17, a scenario data acquisition section 18, and a user information update section 19. FIG. 16 differs from FIGS. 2 and 5, etc. also in that the storage section 20 includes a scenario data storage section 27 and a presentation permission determination information storage section 28.

The event determination section 11 determines occurrence of various events. Specifically, the event determination section 11 determines occurrence of a robot available event that indicates that the user whose user information has been updated in the mobile subsystem or the car subsystem can utilize the robot of the home subsystem. For example, the event determination section 11 determines that a robot available event has occurred when the user has approached (moved to) the place (home) where the robot is situated. When information is transferred via wireless communication, the event determination section 11 may determine occurrence of a robot available event by detecting the radio signal strength. Alternatively, the event determination section 11 may determine that a robot available event has occurred when the portable electronic instrument has been connected to the cradle. When the robot available event has occurred, the robots 1 and 2 are activated, and the user information is downloaded to the user information storage section 22 and the like.

The scenario data storage section 27 stores scenario data that includes a plurality of phrases as the presentation information. The presentation information determination section 14 determines the phrase spoken by the robot based on the scenario data. The robot control section 30 then causes the robot to speak the phrase determined by the presentation information determination section 14.

Specifically, the scenario data storage section 27 stores scenario data in which a plurality of phrases are linked by a branched structure. The presentation information determination section 14 determines the presentation information that is subsequently presented to the user by the robot based on the reaction of the user (first user) to the phrase that has been spoken by the robot.

The user identification section 15 identifies the user. Specifically, the user identification section 15 identifies the user who approached the robot. The robot control section 30 causes the robot 1 to present the presentation information to the first user when the user identification, section 15 has determined that the first user has approached the robot.

This may be implemented by causing the robot to recognize the face of the user, or recognize the voice of the user, for example. For example, the facial image or the voice data of the first user is registered in advance. The facial image or the voice of the user who has approached the robot is recognized using an imaging device (e.g., CCD) or a sound sensor (e.g., microphone), and is determined to coincide with the registered facial image or voice. When the facial image or the voice of the user has coincided with the facial image or voice of the first user, the presentation information is presented to the first user. Alternatively, the robot may receive the ID information from the portable electronic instrument carried by the user, and determine whether or not the received ID information coincides with the ID information registered in advance to determine whether or not the user who has approached the robot is the first user.

The contact state determination section 16 determines a contact state on a sensing surface of the robot (described later). The presentation information determination section 14 determines whether the user has stroked or hit the robot as a reaction to the phrase spoken by the robot (presentation information presented by the robot) based on the determination result of the contact state determination section 16. The presentation information determination section 14 then determines the phrase (presentation information) that is subsequently spoken by the robot.

The contact state determination section 16 determines the contact state on the sensing surface based on output data obtained by performing a calculation process on an output signal (sensor signal) from a microphone (sound sensor) provided under the sensing surface (robot). In this case, the output data is a signal strength (signal strength data), for example. The contact state determination section 16 may compare the signal strength indicated by the output data with a given threshold value to determine whether the user has stroked or hit the robot.

The speak right control section 17 determines whether to give the next phrase speak right (initiative) to the robot 1 or the robot 2 based on the reaction (e.g., stroke, hit, or silence) of the user (first user) to the phrase spoken by the robot. Specifically, the speak right control section 17 determines the robot to which the next phrase speak right (initiative) is given, based on whether the user has made a positive or negative reaction to the phrase spoken by the robot 1 or the robot 2. For example, the speak right control section 17 gives the next phrase speak right (initiative) to the robot for which the user has made a positive reaction, or the robot for which the user has not made a negative reaction. The speak right control process may be implemented by utilizing a speak right flag or the like that indicates that the speak right is given to the robot 1 or the robot 2.

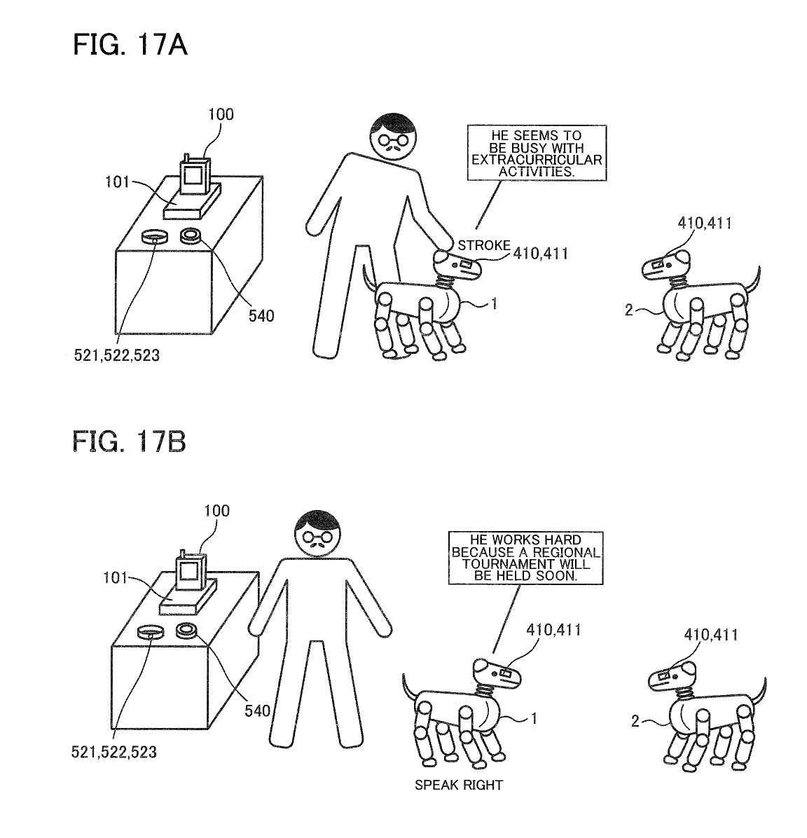

In FIG. 17A, when the robot 1 has spoken a phrase “I think he is busy with extracurricular activities”, the father strokes the robot 1 on the head (i.e., positive response). In this case, the next speak right is given to the robot 1 that has been stroked on the head (for which a positive response was made), as shown in FIG. 17B. Therefore, the robot 1 to which the speak right is given speaks a phrase “Well, a regional tournament will be held soon”. Specifically, since the robots 1 and 2 speak alternately in principle, for example, the next speak right should be given to the robot 2 in FIG. 17B. However, the next speak right is given to the robot 1 that has been stroked on the head by the father in FIG. 17B. In FIG. 17A, the speak right may be given to the robot 1 when the robot 2 has spoken a phrase and the father has hit the robot 2 on the head (i.e., made a negative reaction).

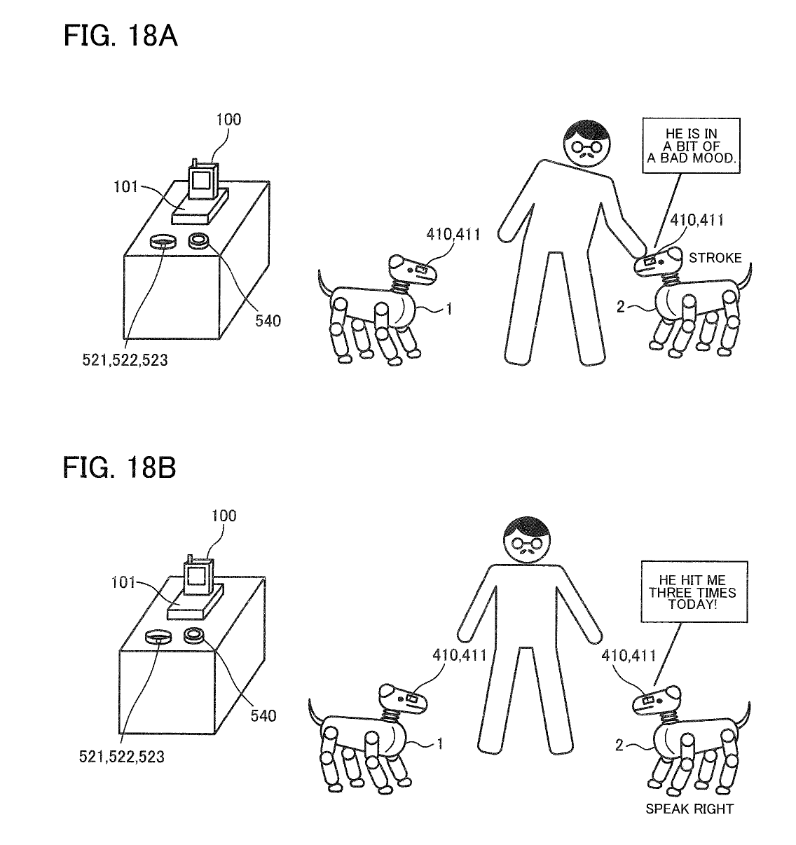

In FIG. 18A, when the robot 2 has spoken a phrase “He is in a bit of a bad mood”, the father strokes the robot 2 on the head (i.e., positive response). In this case, the next speak right is given to the robot 2 that has been stroked on the head, as shown in FIG. 18B. The robot 2 to which the speak right is given speaks a phrase “He hit me three times today!”. In FIG. 18A, the speak right may be given to the robot 2 when the robot 1 has spoken a phrase and the father has hit the robot 1 on the head (i.e., made a negative reaction).

For example, when the robots 1 and 2 necessarily speak alternately, the conversation between the robots 1 and 2 may be monotonous so that the user may lose interest in the conversation between the robots 1 and 2.

However, since the speak right is given variously depending on the reaction of the user when using the speak right control method shown in FIGS. 17A to 18B, a situation in which the conversation between the robots becomes monotonous can be prevented, so that the user rarely loses interest in the conversation between the robots.

The scenario data acquisition section 18 acquires the scenario data. Specifically, the scenario data acquisition section 18 reads the scenario data corresponding to the user information from the scenario data storage section 27 to acquire the scenario data used for a conversation between the robots. Note that the scenario data selected based on the user information may be downloaded to the scenario data storage section 27 through a network, and the scenario data used for a conversation between the robots may be read (selected) from the downloaded scenario data.

In this embodiment, the scenario data is created based on the reaction of the second user (child) to the phrase spoken by the robot, and the scenario data acquisition section 18 acquires the created scenario data, as described with reference to FIGS. 6A to 6C, for example. The presentation information determination section 14 determines the phrase that is spoken to the first user by the robot based on the acquired scenario data.

According to this configuration, the scenario presented to the first user changes based on the reaction of the second user to the phrase spoken by the robot so that a conversation between the robots can be implemented in various ways. In FIG. 6B, when the robot 1 has spoken a phrase “I think he is busy with extracurricular activities”, the child strokes the robot 1 on the head (i.e., positive response). Therefore, the scenario (phrase) concerning the extracurricular activities of the child is selected and presented to the father in FIGS. 7B and 7C.

The user information update section 19 updates the user information in the home environment. Specifically, the user information update section 19 senses the behavior, condition, etc. of the user through a conversation with the robot or the like, and updates the user information in the home environment.

The presentation permission determination information storage section 28 stores presentation permission determination information (presentation permission determination flag) used to determine whether or not to allow information presentation between the users. When the presentation information determination section 14 has determined that information presentation between the first user and the second user is allowed based on the presentation permission determination information, the presentation information determination section 14 determines the presentation information presented to the first user based on the second user information.

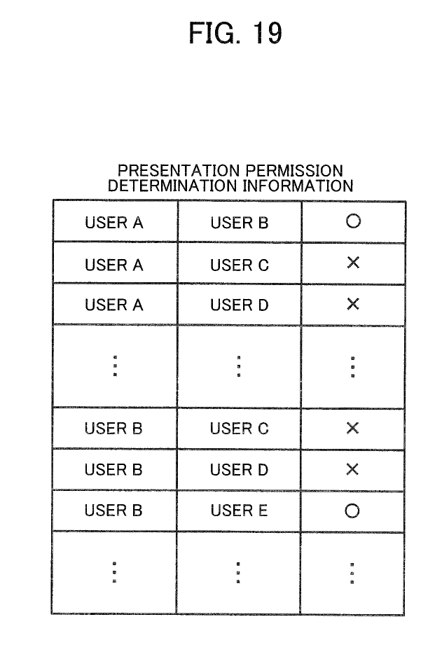

FIG. 19 shows an example of the presentation permission determination information. In FIG. 19, information presentation between the users A and B is allowed, and information presentation between the users C and D is not allowed. Information presentation between the users B and E is allowed, and information presentation between the user B and C and between the user B and D is not allowed.

For example, when the user A has approached the robot, the presentation information based on the user information about the user B can be presented to the user A, but the presentation information based on the user information about the user C cannot be presented to the user A.

It may be undesirable to allow the information about the child to be presented to all of the family members. For example, the information about the child is presented to the father, but is not presented to the mother by utilizing the presentation permission determination information.

In this case, when the father has approached the robot, the robot determines that presentation of the information about the child is allowed based on the presentation permission determination information, and present the presentation information based on the user information about the child. When the mother has approached the robot, the robot determines that presentation of the information about the child is not allowed based on the presentation permission determination information, and does not present the presentation information based on the user information about the child. According to this configuration, since the information about another user is presented to only necessary users, invasion of privacy and the like can be prevented.

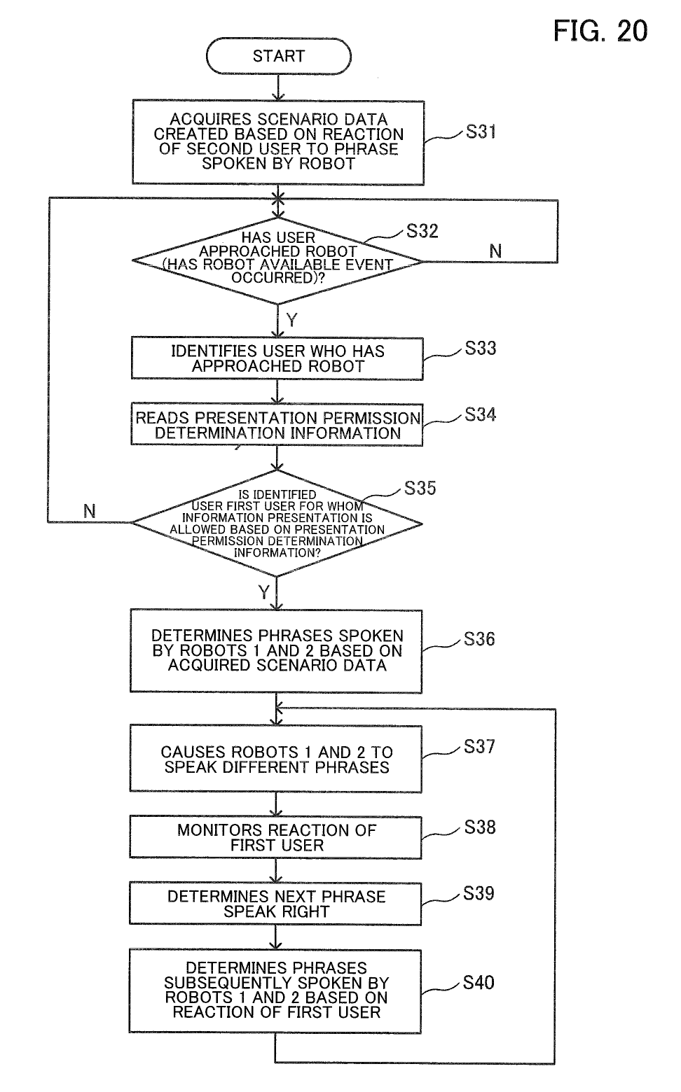

A detailed operation according to this embodiment is described below using a flowchart shown in FIG. 20.

The scenario data created based on the reaction of the second user (child) to the phrase spoken by the robot is acquired (see FIGS. 6A to 6C) (step S31).

Whether or not the user has approached the robot is then determined (step S32). Specifically, whether or not a robot available event has occurred is determined by detecting connection of the portable electronic instrument to the cradle, the radio signal strength, or the like.

The user who has approached the robot is identified (step S33). Specifically, the user is identified based on image recognition, voice recognition, and the like. The presentation permission determination information about the identified user is read from the presentation permission determination information storage section 28 (step S34).

Whether or not the identified user is the first user for whom information presentation is allowed based on the presentation permission determination information is determined (step S35), For example, when the information about the child (second user) can be presented to only the father (first user), whether or not the user who has approached the robot is the father is determined.

When it has been determined that the identified user is the first user, the phrases spoken by the robots 1 and 2 are determined based on the scenario data acquired in the step S31 (see FIGS. 7A to 7C) (step S36). The robots 1 and 2 are then caused to speak different phrases (step S37).

The reaction of the user to the phrases spoken by the robots 1 and 2 is monitored (step S38). Whether to give the next phrase speak right to the robot 1 or the robot 2 is determined by the method shown in FIGS. 17A to 18B (step S39). The phrases that are subsequently spoken by the robots 1 and 2 are determined based on the first reaction of the user (step S40).

9.2 Specific Example of Scenario

A specific example of the scenario data and the scenario data selection method used in this embodiment is described below.

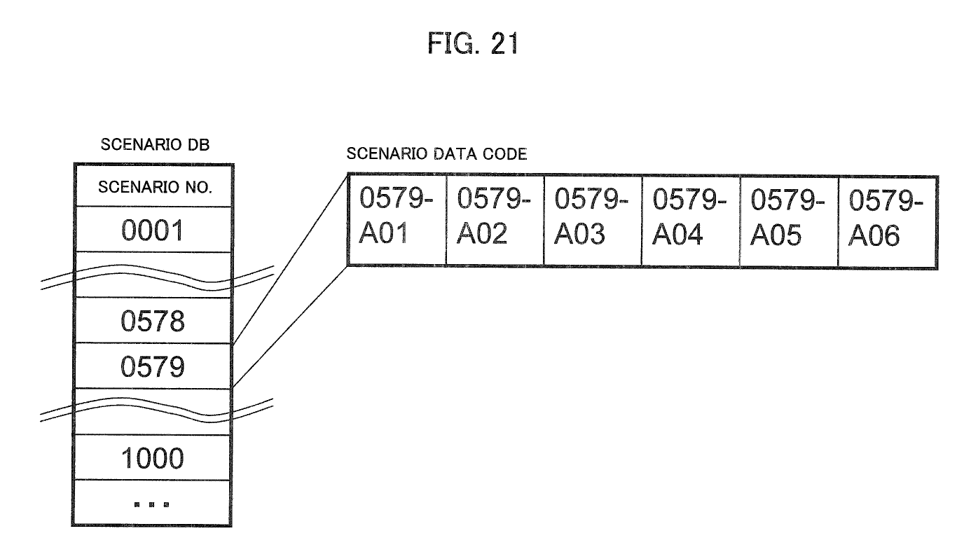

As shown in FIG. 21, a scenario number (No.) is assigned to each piece of scenario data stored in the scenario database (DB). The scenario data specified by the scenario number includes a plurality of scenario data codes, and each phrase (text data) is designated by the scenario data code. In FIG. 21, the scenario data having a scenario number of 0579 is selected based on the second user information. The scenario data having a scenario number of 0579 includes scenario data codes A01 to A06. The scenario data codes A01 to A06 indicate phrases sequentially spoken by the robot. The conversation between the robots based on the second information described with reference to FIGS. 3A to 3C is implemented by utilizing the scenario data.

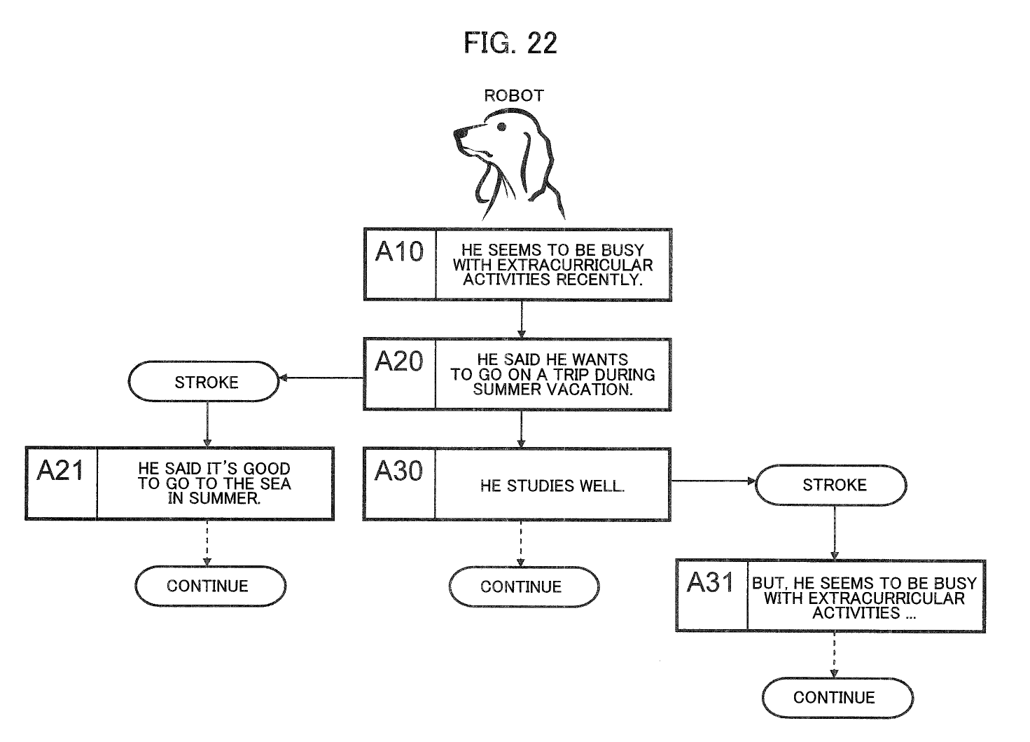

FIG. 22 shows an example of a scenario that present a topic concerning the child to the father.

For example, the robot speaks a phrase “He seems to be busy with extracurricular activities recently”, and then speaks a phrase “He said he wants to go on a trip during summer vacation”. When the father who has listened to the phrase has stroked the robot, the system estimates that the father is interested in the child's wishes about a trip during summer vacation. In this case, the robot speaks “He said it's good to go to the sea in summer” (i.e., notifies the father of the child's wishes obtained from a conversation with the child). The robot then continues to talk about a trip during summer vacation.

When the father has made no reaction when the robot has spoken a phrase “He said he wants to go on a trip during summer vacation”, the system estimates that the father is not interested in this topic, and speaks “He studies well”. When the father who has listened to the phrase has stroked the robot, the system estimates that the father is interested in study of the child. In this case, the robot speaks “But, he seems to be busy with extracurricular activities . . . ”.

In FIG. 22, the phrase that is subsequently spoken by the robot is thus determined based on the reaction of the father to the phrase that has been spoken by the robot. The system estimates the topic the father is interested in by detecting the reaction (e.g., stroke or hit) of the father.

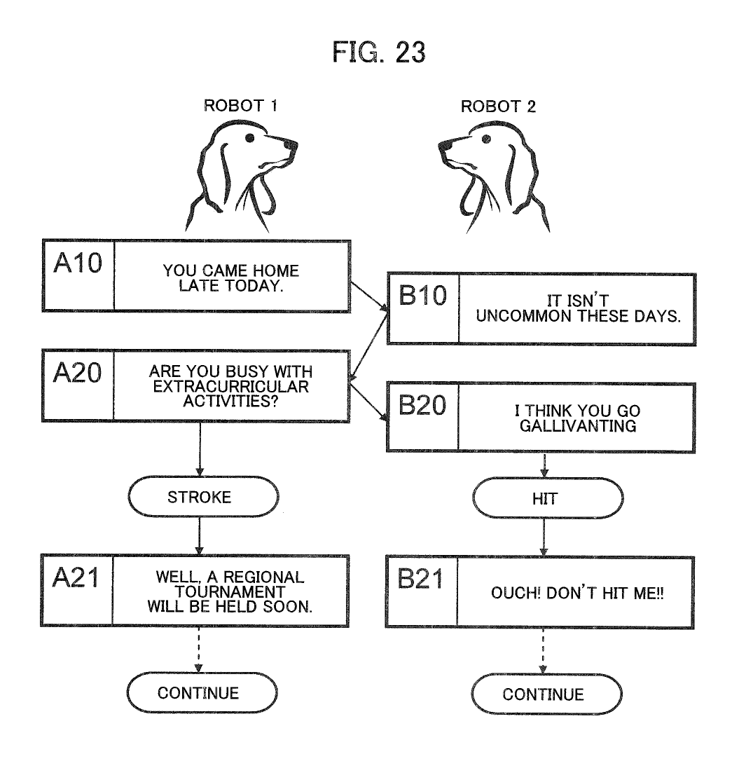

FIG. 23 shows an example of a scenario that collects the user information about the child through a conversation between the robots 1 and 2.

The robot 1 speaks a phrase “You came home late today”, and the robot 2 speaks a phrase “It isn't uncommon these days”. The robot 1 speaks a phrase “I think you are busy with extracurricular activities”, and the robot 2 speaks a phrase “I think you go gallivanting”.

When the child has stroked the robot 1, the system estimates that the child came home late due to extracurricular activities. In this case, the speak right is given to the robot 1, and the robot 1 speaks a phrase “Well, a regional tournament will be held soon”. The robots 1 and 2 then have a conversation about extracurricular activities.

When the child has hit the robot 2, the speak right is given to the robot 2, and the robot 2 speaks a phrase “Ouch! Don't hit me!!”.

In FIG. 23, the user information about the child is thus collected and updated through the conversation between the robots 1 and 2. Therefore, the second user information about the child is automatically acquired without being noticed by the child.

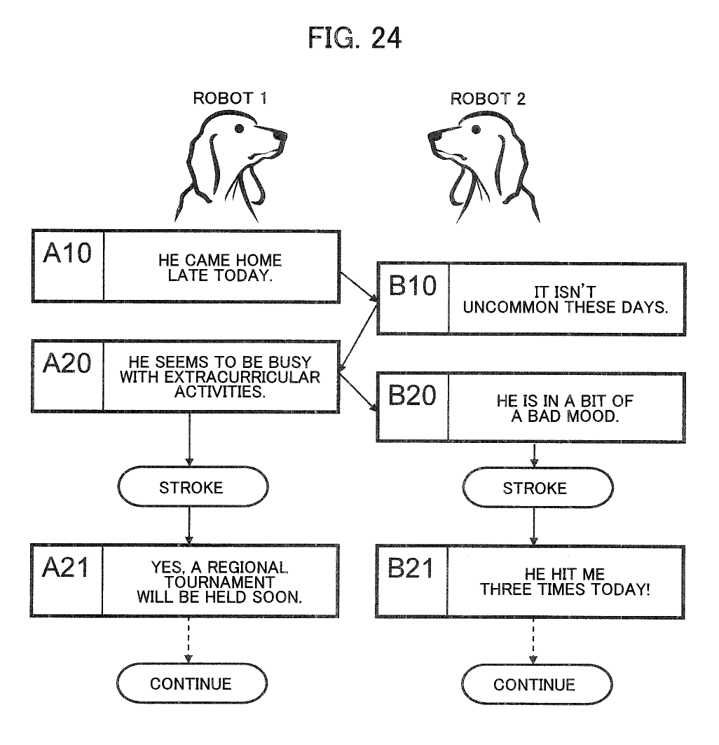

FIG. 24 shows an example of a scenario that is presented to the father based on the second user information collected in FIG. 23.

In FIG. 23, the robot 1 speaks a phrase “He came home late today”, and the robot 2 speaks a phrase “It isn't uncommon these days” according to the scenario based on the second user information collected in FIG. 23. The robot 1 then speaks a phrase “He seems to be busy with extracurricular activities”, and the robot 2 speaks a phrase “He is in a bit of a bad mood”. Specifically, the robots 1 and 2 speak different phrases based on the identical second user information.

When the father has stroked the robot 1, the system estimates that the father is interested in extracurricular activities of the child. Therefore, the speak right is given to the robot 1, and the robot 1 speaks a phrase “Yes, a regional tournament will be held soon”. The robots 1 and 2 then have a conversation about extracurricular activities of the child.

When the father has stroked the robot 2, the speak right is given to the robot 2, and the robot 2 speaks a phrase “He hit me three times today!”.

In FIG. 24, the information about the child collected through the conversation between the robots 1 and 2 is thus presented to the father through the conversation between the robots 1 and 2. Therefore, an indirect communication means through the robots 1 and 2 can be provided.

10. Contact State Determination

A specific example of a method of determining an operation (e.g., hitting or stroking the robot) is described below.

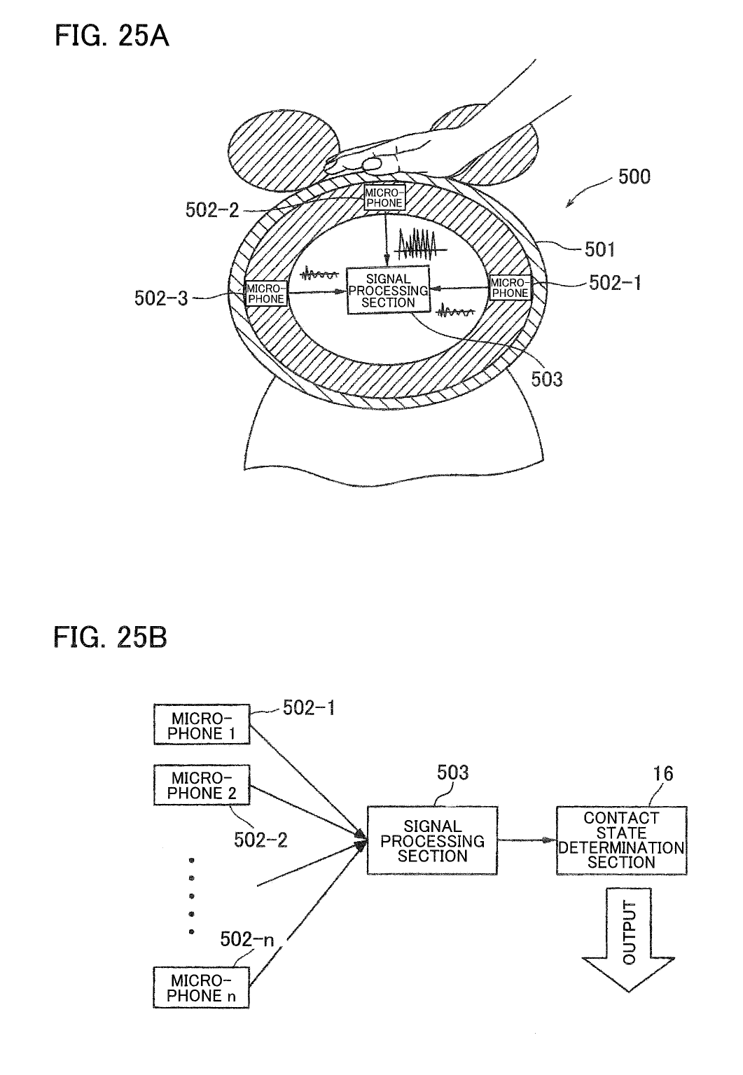

FIG. 25A shows an example of a stuffed toy-type robot 500. The surface of the robot 500 functions as a sensing surface 501. The robot 500 includes microphones 502-1, 502-2, and 502-3 that are provided under the sensing surface 501. The robot 500 also includes a signal processing section 503 that processes output signals from the microphones 502-1, 502-2, and 502-3 and outputs output data.

As shown in FIG. 25B (functional block diagram), the output signals from the microphones 502-1, 502-2, . . . 502-n are input to the signal processing section 503. The signal processing section 503 processes/converts the analog output signals by noise removal, signal amplification, and the like. The signal processing section 503 calculates the signal strength and the like, and outputs digital output data. The contact state determination section 16 performs a threshold value comparison process, a contact state classification process, and the like.

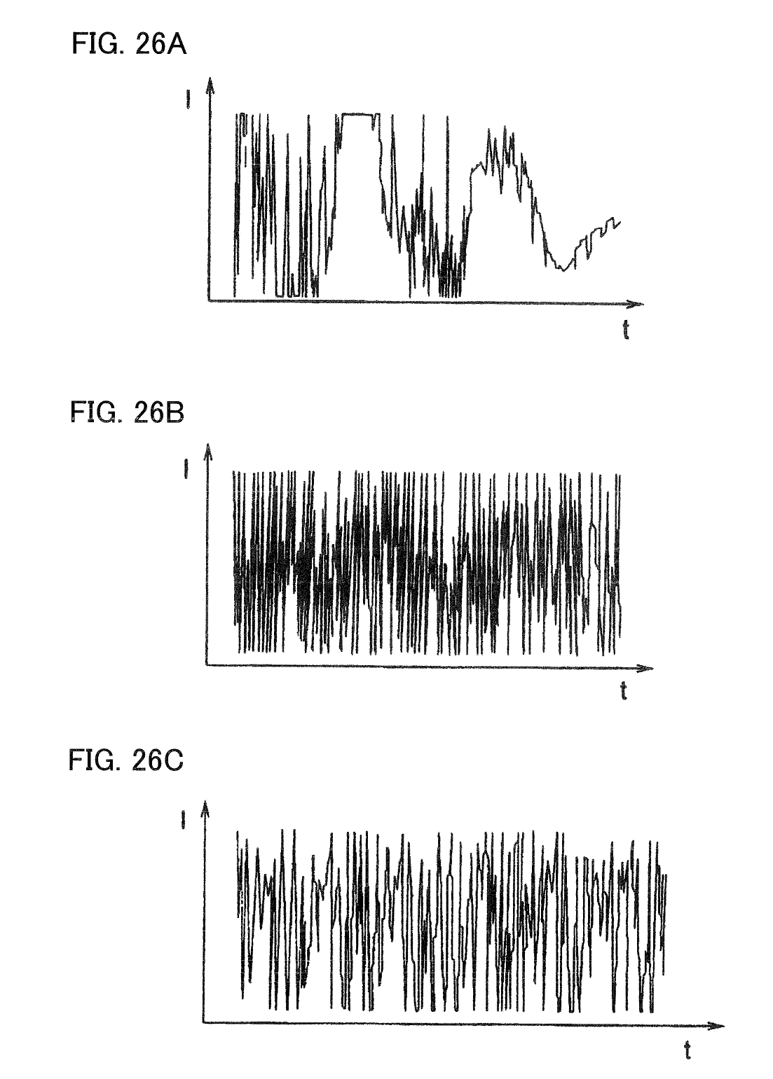

FIGS. 26A, 26B, and 26C show voice waveform examples when hitting the sensing surface 501, stroking the sensing surface 501, and speaking into the microphones. The horizontal axis indicates the time, and the vertical axis indicates the signal strength.

A high signal strength is obtained when hitting the sensing surface 501 (FIG. 26A) and stroking the sensing surface 501 (FIG. 26B). A high signal strength temporarily occurs when hitting the sensing surface 501, and successively occurs when stroking the sensing surface 501. As shown in FIG. 26C, the signal strength of the waveform when strongly pronouncing a word (e.g., “aaa”) is lower than that when hitting the sensing surface 501 (FIG. 26A) or stroking the sensing surface 501 (FIG. 26B).

A hit state, a stroked state, and another state can be detected by providing a threshold value that utilizes such a difference. A position where the strongest signal is generated can be detected to be a hit area or a stroked area by utilizing the microphones 502-1, 502-2, and 502-3.

Specifically, the microphones 502-1, 502-2, and 502-3 provided in the robot 500 detect sound that propagate inside the robot 500 when the hand of the user or the like has come in contact with the sensing surface 501 of the robot 500, and convert the detected sound into an electrical signal.

The signal processing section 503 subjects the output signals (sound signals) from the microphones 502-1, 502-2, and 502-3 to noise removal, signal amplification, and A/D conversion, and outputs output data. The signal strength can be calculated by converting the output data into an absolute value, and storing (accumulating) the value for a given period of time. The calculated signal strength is compared with a threshold value TH. If the signal strength exceeds the threshold value TH, it is determined that a contact state has been detected, and a contact state detection count is incremented. The contact state detection process is repeated for a given period of time.

When the given period of time has elapsed, the contact state determination section 16 compares a condition set in advance with the contact state detection count to detect a stroked state or a hit state using the following condition, for example. Specifically, the contact state determination section 16 detects a stroked state or a hit state by utilizing a phenomenon in which the contact state detection count increases when stroking the sensing surface 501 since the contact state continues, but decreases when hitting the sensing surface 501.

Detected state (Detection count/maximum detection count)×100(%)

Stroked state 25% or more

Hit state 10% or more and less than 25%

Non-detected state Less than 10%

This makes it possible to determine a hit state, a stroked state, and another state (non-detected state) by utilizing at least one microphone. Moreover, the contact area can be determined by providing a plurality of microphones and comparing the contact state detection count of each microphone.

11. Determination of Presentation Information Based on First User Information and Second User Information

In this embodiment, the presentation information presented to the first user is determined taking account of the first user information and the second user information, for example. Specifically, the weighting of the first user information and the weighting of the second user information when determining the presentation information presented to the first user are changed with the passage of time.

For example, a robot (home subsystem) available event occurs when the first user (father) has returned home or approached the robot. Specifically, when a situation in which the first user has returned home has been detected by the UPS sensor of the wearable sensor or the door sensor or based on connection of the portable electronic instrument to the cradle, or a situation in which the first user has approached the robot has been detected based on the wireless signal strength of wireless communication or by the touch sensor of the robot, the event determination section 11 shown in FIG. 16 determines that a robot available event has occurred. Specifically, the event determination section 11 determines that a robot available event that indicates that the robots have become available has occurred.

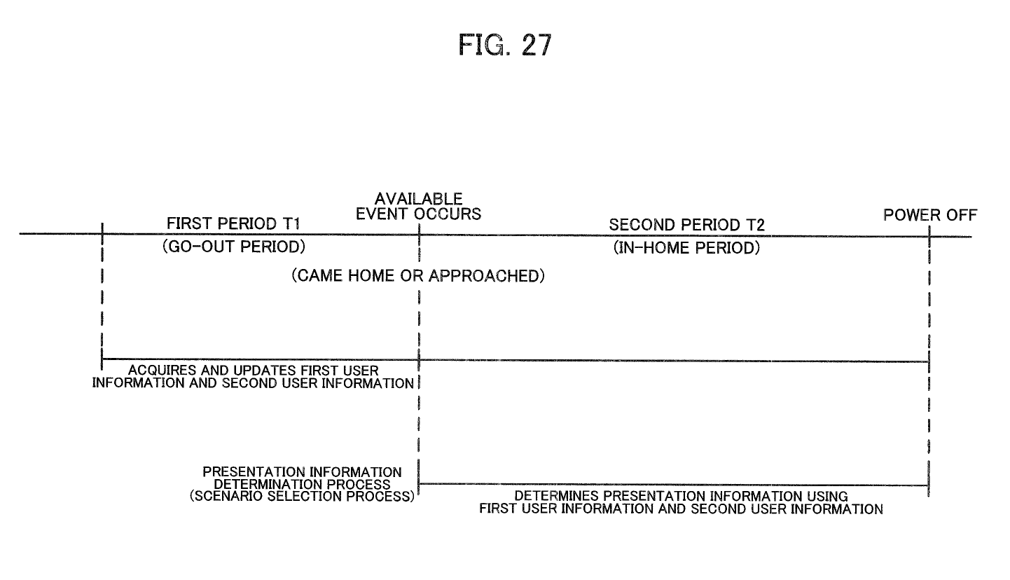

In FIG. 27, a go-out period (robot unavailable period of the robot or robot-first user non-approach period) before the available event has occurred is referred to as a first period T1, and an in-home period (robot available period or robot-first user approach period) after the available event has occurred is referred to as a second period T2, for example.

The first user information about the first user (father) and the second user information about the second user (child) are acquired (updated) in the first period T1. For example, the first user information (first user historical information) may be acquired by measuring the behavior (e.g., walking, speech, or meal), the condition (e.g., tiredness, tension, hungry, mental condition, or physical condition), or the environment (e.g., place, brightness, or temperature) of the first user in the first period T1 using the behavior sensor, the condition sensor, and the environment sensor of the wearable sensor of the first user. Specifically, the user information update section of the portable electronic instrument 100-1 updates the first user information stored in the user information storage section of the portable electronic instrument 100-1 based on the sensor information from these sensors so that the first user information is acquired in the first period T1.

Likewise, the second user information about the second user (child) may be acquired by measuring the behavior, the condition, or the environment of the second user in the first period T1 using the wearable sensor of the second user. Specifically, the user information update section of the portable electronic instrument 100-2 updates the second user information stored in the user information storage section of the portable electronic instrument 100-2 based on the sensor information from these sensors so that the second user information is acquired in the first period T1. Note that the second user information may also be acquired through a conversation with the robots (see FIGS. 6A to 6C).

When the available event of the robot 1 has occurred, the first user information and the second user information updated in the first period T1 are transferred from the user information storage sections of the portable electronic instruments 100-1 and 100-2 to the user information storage section 22 (user historical information storage section 23) of the robot 1. This makes it possible for the presentation information determination section 14 to determine the presentation information presented to the user by the robot 1 (select the scenario) based on the first user information and the second user information transferred from the portable electronic instruments 100-1 and 100-2.

Note that the first user information may also be updated in the second period T2 after the available event has occurred by measuring the behavior, the condition, or the environment of the first user using the robot-mounted sensor 34 or other sensors (e.g., wearable sensor or home sensor).

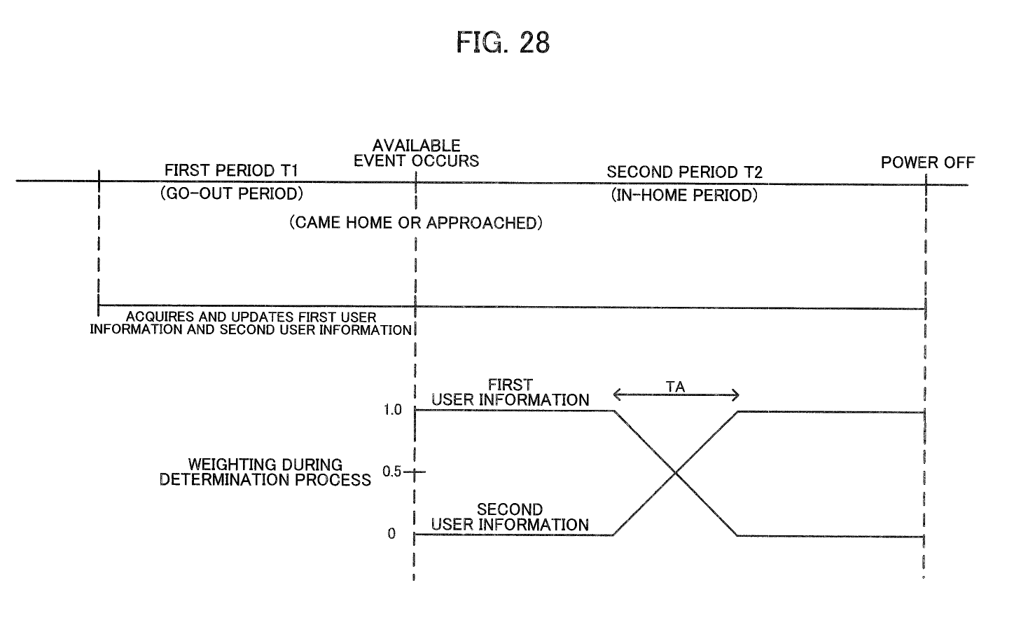

As shown in FIG. 28, the presentation information determination section 14 determines the presentation information presented to the first user by the robot 1 based on the first user information and the second user information acquired in the first period T1 (or second period T2) and the like. Specifically, the presentation information determination section 14 determines the scenario used for the robot 1 based on the first user information and the second user information. This makes it possible to provide the first user (father) who came home with a topic concerning the second user (child) and a topic concerning the first user outside the home to prompt the first user to become aware of his behavior etc. outside the home.

More specifically, the presentation information determination section 14 changes the weighting (weighting coefficient) of the first user information and the weighting of the second user information when determining the presentation information with the passage of time.

In FIG. 28, when the available event of the robot 1 has occurred (when the user has returned home or until a given period elapses after the user has returned home), the weighting of the first user information is higher than the weighting of the second user information during the determination process. For example, the weighting of the first user information is “1.0”, and the weighting of the second user information is “0”.

The weighting of the first user information decreases and the weighting of the second user information increases in a weighting change period TA. The weighting of the second user information is higher than the weighting of the first user information after the weighting change period TA. For example, the weighting of the first user information is “0”, and the weighting of the second user information is “1.0”.

In FIG. 28, the weighting of the first user information is increased during the determination process while decreasing the weighting of the second user information when the available event has occurred, and the weighting of the first user information is then decreased while increasing the weighting of the second user information. Specifically, in the second period T2, the weighting of the first user information during the presentation information determination process is decreased with the passage of time while increasing the weighting of the second user historical information with the passage of time.

Therefore, a topic concerning the behavior etc. of the first user (father) in the first period T1 (e.g., go-out period) is provided by the robot 1 in the first half of the second period T1. The robot 1 then provides a topic concerning the behavior etc. of the second user (child).

According to this configuration, the first user is provided with a topic concerning himself immediately after the first user has returned home, and provided with a topic concerning the second user (another person) after the first user has felt relaxed. This makes it possible to provide the first user with a more natural topic.

For example, when the first user has returned home when the second user stays at home together with the robot 1, it is expected that the first user attracts attention as compared with the second user. Therefore, a topic concerning the first user is mainly presented immediately after the first user has returned home, and topics concerning the first user and the second user are provided evenly after the first user has felt relaxed.

Note that the weighting change method is not limited to the method shown in FIG. 28. For example, the weighting of the second user information may be set to be higher than the weighting of the first user information in the first half, and the weighting of the first user information may then be set to be higher than the weighting of the second user information. A change in weighting may be programmed in advance in the robot 1 and the like, or the user may arbitrarily change the weighting as he likes.

When acquiring (updating) the first user information in the second period T2, the weighting of the first user information acquired in the first period T1 and the weighting of the first user information acquired in the second period T2 may be changed with the passage of time when determining the presentation information. For example, the weighting of the first user information acquired in the first period T1 is set to be higher than the weighting of the first user information acquired in the second period T2 immediately after the available event of the robot 1 has occurred, and the weighting of the first user information acquired in the second period T2 is set to be higher than the weighting of the first user information acquired in the first period T1 with the passage of time.

Examples of the weighting of the user information during the presentation information determination process include the selection probability of the scenario selected based on the user information. Specifically, when increasing the weighting of the first user information, the scenario is selected based on the first user information rather than the second user information. More specifically, the selection probability of the scenario based on the first user information is increased. On the other hand, when increasing the weighting of the second user information, the scenario is selected based on the second user information rather than the first user information. Specifically, the selection probability of the scenario based on the second user information is increased.

In FIG. 28, since the weighting of the first user information is higher than the weighting of the second user information in the first half of the second period T2, the selection probability of the scenario based on the first user information increases. Therefore, the robot 1 speaks about the behavior etc. of the first user during the day in the first half of the second period T2. On the other hand, since the weighting of the second user information is higher than the weighting of the first user information in the second half of the second period T2, the selection probability of the scenario based on the second user information increases. Therefore, the robot 1 speaks about the behavior etc. of the second user during the day in the second half of the second period T2. This makes it possible to gradually change the topic of the scenario presented to the user with the passage of time to implement a more natural and diverse conversation between the robots.

Although some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention. Any term cited with a different term having a broader meaning or the same meaning at least once in the specification and the drawings can be replaced by the different term in any place in the specification and the drawings. The configurations and the operations of the robot control system and the robot are not limited to those described with reference to the above embodiments. Various modifications and variations may be made.

1. A robot control system that controls a robot, the robot control system comprising:
a user information acquisition section that acquires user information that is obtained based on sensor information from at least one of a behavior sensor that measures a behavior of a user, a condition sensor that measures a condition of the user, and an environment sensor that measures an environment of the user;
a presentation information determination section that determines presentation information presented to the user by the robot based on the acquired user information; and
a robot control section that controls the robot to present the presentation information to the user,
the user information acquisition section acquiring second user information that is the user information about a second user;
the presentation information determination section determining the presentation information presented to a first user based on the acquired second user information; and
the robot control section causing the robot to present the presentation information determined based on the second user information to the first user.

2. The robot control system as defined in claim 1,
the user information acquisition section acquiring first user information that is the user information about the first user, and the second user information that is the user information about the second user; and
the presentation information determination section determining the presentation information presented to the first user based on the acquired first user information and the acquired second user information.

3. The robot control system as defined in claim 2,
the presentation information determination section determining a presentation timing of the presentation information based on the first user information, and determining a content of the presentation information based on the second user information; and
the robot control section causing the robot to present the presentation information having the determined content to the first user at the determined presentation timing.

4. The robot control system as defined in claim 2,
the presentation information determination section changing weighting of the first user information and weighting of the second user information when determining the presentation information presented to the first user with the passage of time.

5. The robot control system as defined in claim 4, further comprising:
an event determination section that determines occurrence of an available event that indicates that the robot is available to the first user,
the presentation information determination section increasing the weighting of the first user information while decreasing the weighting of the second user information when determining the presentation information when the available event has occurred, and then decreasing the weighting of the first user information while increasing the weighting of the second user information.

6. The robot control system as defined in claim 1,
the presentation information determination section determining the presentation information that is subsequently presented to the first user by the robot based on a reaction of the first user to the presentation information that has been presented by the robot.

7. The robot control system as defined in claim 6, further comprising:
a contact state determination section that determines a contact state on a sensing surface of the robot,
the presentation information determination section determining whether the first user has stroked or hit the robot as the reaction of the first user to the presentation information presented by the robot based on the determination result of the contact state determination section, and determining the presentation information that is subsequently presented to the first user.

8. The robot control system as defined in claim 7,
the contact state determination section determining the contact state on the sensing surface based on output data obtained by performing a calculation process on an output signal from a microphone provided under the sensing surface.

9. The robot control system as defined in claim 8,
the output data being a signal strength; and
the contact state determination section comparing the signal strength with a given threshold value to determine whether the first user has stroked or hit the robot.

10. The robot control system as defined in claim 1,
the presentation information determination section determining the presentation information presented to the first user so that a first robot and a second robot present different types of presentation information based on the identical acquired second user information.

11. The robot control system as defined in claim 10,
the first robot being set as a master, and the second robot being set as a slave; and
the presentation information determination section that is provided in the master-side first robot instructing the slave-side second robot to present the presentation information to the first user.

12. The robot control system as defined in claim 11, further comprising:
a communication section that transmits instruction information from the master-side first robot to the slave-side second robot, the instruction information instructing presentation of the presentation information.

13. The robot control system as defined in claim 1,
the user information acquisition section acquiring the second user information about the second user through a network; and
the presentation information determination section determining the presentation information presented to the first user based on the second user information acquired through the network.

14. The robot control system as defined in claim 1,
the user information acquisition section acquiring second user historical information as the second user information, the second user historical information being at least one of a behavior history, a condition history, and an environment history of the second user; and
the presentation information determination section determining the presentation information presented to the first user by the robot based on the acquired second user historical information.

15. The robot control system as defined in claim 14,
the second user historical information being information that is updated based on sensor information from a wearable sensor of the second user.

16. The robot control system as defined in claim 1, further comprising:
a user identification section that identifies a user who has approached the robot,
the robot control section causing the robot to present the presentation information to the first user when the user identification section has determined that the first user has approached the robot.

17. The robot control system as defined in claim 1, further comprising:
a presentation permission determination information storage section that stores presentation permission determination information that indicates whether or not to allow information presentation between users,
the presentation information determination section determining the presentation information presented to the first user based on the second user information when the presentation information determination section has determined that information presentation between the first user and the second user is allowed based on the presentation permission determination information.

18. The robot control system as defined in claim 1, further comprising:
a scenario data storage section that stores scenario data that includes a plurality of phrases as the presentation information,
the presentation information determination section determining a phrase spoken to the first user by the robot based on the scenario data; and
the robot control section causing the robot to speak the determined phrase.

19. The robot control system as defined in claim 18,
the scenario data storage section storing the scenario data in which a plurality of phrases are linked by a branched structure; and
the presentation information determination section determining a phrase that is subsequently spoken by the robot based on a reaction of the first user to the phrase that has been spoken by the robot.

20. The robot control system as defined in claim 18, further comprising:
a scenario data acquisition section that acquires scenario data created based on a reaction of the second user to the phrase spoken by the robot,
the presentation information determination section determining a phrase spoken to the first user by the robot based on the scenario data acquired based on the reaction of the second user.

21. The robot control system as defined in claim 18,
the presentation information determination section determining a phrase spoken to the first user so that a first robot and a second robot speak different phrases based on the identical acquired second user information; and
the robot control system further comprising a speak right control section that controls whether to give a next phrase speak right to the first robot or the second robot based on a reaction of the first user to the phrase that has been spoken by the robot.

22. The robot control system as defined in claim 21,
the speak right control section determining a robot to which the next phrase speak right is given, based on whether the first user has made a positive reaction or a negative reaction to a phrase spoken by the first robot or the second robot.

23. A robot comprising:
the robot control system as defined in claim 1; and
a robot motion mechanism that is a control target of the robot control system.

24. A robot control program, the program causing a computer to function as:
a user information acquisition section that acquires user information that is obtained based on sensor information from at least one of a behavior sensor that measures a behavior of a user, a condition sensor that measures a condition of the user, and an environment sensor that measures an environment of the user;
a presentation information determination section that determines presentation information presented to the user by the robot based on the acquired user information; and
a robot control section that controls the robot to present the presentation information to the user,
the user information acquisition section acquiring second user information that is the user information about a second user;
the presentation information determination section determining the presentation information presented to a first user based on the acquired second user information; and
the robot control section causes the robot to present the presentation information determined based on the second user information to the first user.

25. A computer-readable information storage medium storing the program as defined in claim 24.
